(19) United States
(12) Patent Application Publication
(10) Pub. No.: US 2026/0251766 A1
(43) Pub. Date: Aug. 27, 2026

(54) LIGHT BEAM DEFLECTION DEVICE AND LASER RADAR

(71) Applicant: BOE Technology Group Co., Ltd., Beijing (CN)

(72) Inventors: Yuehua LIU, Beijing (CN); Yidan PENG, Beijing (CN); Jian ZHOU, Beijing (CN); Long WANG, Beijing (CN); Feng QU, Beijing (CN)

(73) Assignee: BOE Technology Group Co., Ltd., Beijing (CN)

(21) Appl. No.: 18/995,502

(22) PCT Filed: Aug. 18, 2023
(86) PCT No.: PCT/CN2023/113800

§ 371 Date: Jan. 16, 2025

(51) Int. Cl. G01S 7/484; G01S 17/02; G02F 1/1335; G02F 1/13363; G02F 1/1337

(52) U.S. Cl. CPC G01S 7/484; G02F 1/133502; G02F 1/133638; G02F 1/1337; G01S 17/02; G02F 2201/30; G02F 2413/02

(57) ABSTRACT

A light beam deflection device and a laser radar. The light beam deflection device includes a light beam deflection structure including a liquid crystal variable wave plate and a liquid crystal polarization grating, the liquid crystal variable wave plate includes a first liquid crystal layer and a first driver configured to drive the first liquid crystal layer, the first liquid crystal layer includes a first state and a second state, in the first state, the liquid crystal variable wave plate can change a polarization state of light, and in the second state, the liquid crystal variable wave plate does not change a polarization state of light; the liquid crystal polarization grating includes a second liquid crystal layer including a third state, and in the third state, the liquid crystal polarization grating changes a polarization state and a deflection angle of the light.

### TECHNICAL FIELD

The present disclosure relates to a light beam deflection device and a laser radar.

### BACKGROUND

Beam deflection technology is a technology to dynamically and accurately control the direction of the emitted laser beam. This technology has a wide application prospect in many fields such as autonomous driving, intelligent robots, automatic logistics or urban surveying and mapping, etc.

Laser radar is a radar system that emits laser beam to detect the position and speed of target. The working principle of the laser radar is to emit a detection signal to the target, and then compare the received signal reflected from the target with the emitted signal, and after proper processing, the relevant information of the target, such as the distance, azimuth, altitude, speed, posture and even shape of the target, can be obtained, so that the target can be detected, tracked and identified.

### SUMMARY

The embodiment of the present disclosure provides a light beam deflection device. By setting states of a plurality of first liquid crystal layers, light with a plurality of different deflection directions and deflection angles can be combined and obtained after the light passing through a plurality of first light beam deflection structures, so that the light with different deflection directions and deflection angles can be obtained.

At least one embodiment of the present disclosure provides a light beam deflection device, including a first side and a second side opposite in a first direction, and including a light beam deflection structure, the light beam deflection structure including: a liquid crystal variable wave plate, including a first liquid crystal layer and a first driver, wherein the first liquid crystal layer includes a first state and a second state, the first driver is configured to drive the first liquid crystal layer to be in the first state or the second state, in the first state, the liquid crystal variable wave plate is configured to change light of a first polarization state into light of a second polarization state or change light of the second polarization state into light of the first polarization state, and in the second state, the liquid crystal variable wave plate is configured to not to change a polarization state of light; and a liquid crystal polarization grating, arranged at a side of the liquid crystal variable wave plate away from the first side, and including a second liquid crystal layer, wherein the second liquid crystal layer includes a third state, in the third state, the liquid crystal polarization grating is configured to change light of the first polarization state into light of the second polarization state and deflect the light toward a first deflection direction by a set angle, or change light of the second polarization state into light of the first polarization state and deflect the light toward a second deflection direction by the set angle, and the first deflection direction and the second deflection direction are symmetrical with respect to a propagation direction of the light, wherein the light beam deflection structure includes a first light beam deflection structure, the first deflection direction and the second deflection direction of the liquid crystal polarization grating in the first light beam deflection structure are located in a first plane where a first direction and a second direction are located, and the second direction is perpendicular to the first direction, the light beam deflection device includes a plurality of first light beam deflection structures which are arranged along the first direction.

For example, in the light beam deflection device provided by an embodiment of the present disclosure, a periodic arrangement direction of liquid crystal directors of the second liquid crystal layer of the liquid crystal polarization grating in the first light beam deflection structure is the second direction.

For example, in the light beam deflection device provided by an embodiment of the present disclosure, the first polarization state is a right-handed circularly polarization state, and the second polarization state is a left-handed circularly polarization state.

For example, in the light beam deflection device provided by an embodiment of the present disclosure, the liquid crystal polarization grating further includes a second driver, and the second liquid crystal layer further includes a fourth state, the second driver is configured to drive the second liquid crystal layer so that the second liquid crystal layer is in the third state or the fourth state, and in the fourth state, the liquid crystal polarization grating is configured not to change the polarization state and a deflection angle of the light.

For example, in the light beam deflection device provided by an embodiment of the present disclosure, numerical values of a plurality of set angles of the plurality of first light beam deflection structures are different.

For example, in the light beam deflection device provided by an embodiment of the present disclosure, the numerical values of the plurality of set angles form an arithmetic sequence or a geometric sequence.

For example, in the light beam deflection device provided by an embodiment of the present disclosure, the plurality of first light beam deflection structures include four first light beam deflection structures, and set angles of the four first light beam deflection structures are 5 degrees, 10 degrees, 15 degrees and 20 degrees, respectively.

For example, in the light beam deflection device provided by an embodiment of the present disclosure, the plurality of first light beam deflection structures include four first light beam deflection structures, and set angles of liquid crystal polarization gratings of the four first light beam deflection structures are 5 degrees, 10 degrees, 20 degrees and 20 degrees, respectively.

For example, in the light beam deflection device provided by an embodiment of the present disclosure, the light beam deflection structure further includes a second light beam deflection structure, the first deflection direction and the second deflection direction of the liquid crystal polarization grating of the second light beam deflection structure are located in a second plane where the first direction and a third direction are located, and the third direction is perpendicular to both the first direction and the second direction, the light beam deflection device includes at least one second light beam deflection structure, and the plurality of first light beam deflection structures and the at least one second light beam deflection structure are arranged along the first direction.

For example, in the light beam deflection device provided by an embodiment of the present disclosure, the at least one second light beam deflection structure is located at a side of the plurality of first light beam deflection structures away from the first side or away from the second side.

For example, in the light beam deflection device provided by an embodiment of the present disclosure, a periodic arrangement direction of liquid crystal directors of the second liquid crystal layer of the second light beam deflection structure is the third direction.

For example, in the light beam deflection device provided by an embodiment of the present disclosure, the light beam deflection device includes a plurality of second light beam deflection structures arranged in the first direction.

For example, in the light beam deflection device provided by an embodiment of the present disclosure, the light beam deflection device includes the four first light beam deflection structures and two second light beam deflection structures, the set angles of the liquid crystal polarization gratings of the four first light beam deflection structures are respectively 5 degrees, 10 degrees, 20 degrees and 20 degrees, and set angles of the two second light beam deflection structures are respectively 10 degrees and 20 degrees.

For example, in the light beam deflection device provided by an embodiment of the present disclosure, the liquid crystal variable wave plate further includes: a first substrate; a second substrate, arranged opposite to the first substrate, wherein the first liquid crystal layer is located between the first substrate and the second substrate; a first alignment layer, located between the first liquid crystal layer and the first substrate; a second alignment layer, located between the first liquid crystal layer and the second substrate; a first transparent conductive layer, located between the first alignment layer and the first substrate; and a second transparent conductive layer, located between the second alignment layer and the second substrate, wherein, the first driver includes the first transparent conductive layer and the second transparent conductive layer, in a case that a voltage signal between the first transparent conductive layer and the second transparent conductive layer is a first voltage, the first liquid crystal layer is in the first state, and in a case that the voltage signal between the first transparent conductive layer and the second transparent conductive layer is a second voltage, the first liquid crystal layer is in the second state.

For example, in the light beam deflection device provided by an embodiment of the present disclosure, the first liquid crystal layer includes nematic liquid crystal or ferroelectric liquid crystal.

For example, in the light beam deflection device provided by an embodiment of the present disclosure, the liquid crystal variable wave plate further includes: a first antireflection film, located at a side of the first substrate away from the first transparent conductive layer; and a second antireflection film, located at a side of the second substrate away from the second transparent conductive layer.

For example, in the light beam deflection device provided by an embodiment of the present disclosure, the liquid crystal variable wave plate further includes: a first substrate; a second substrate, arranged opposite to the first substrate, wherein the first liquid crystal layer is located between the first substrate and the second substrate; a first alignment layer, located between the first liquid crystal layer and the first substrate; a second alignment layer, located between the first liquid crystal layer and the second substrate; a first transparent conductive layer, located between the first alignment layer and the first substrate; a second transparent conductive layer, located between the second alignment layer and the second substrate; a first quarter-wave plate, located at a side of the first substrate close to the first side; and a second quarter-wave plate, located at a side of the second substrate away from the first side, wherein, the first driver includes the first transparent conductive layer and the second transparent conductive layer, in a case that a voltage signal between the first transparent conductive layer and the second transparent conductive layer is a first voltage, the first liquid crystal layer is in the first state, and in a case that the voltage signal between the first transparent conductive layer and the second transparent conductive layer is a second voltage, the first liquid crystal layer is in the second state.

For example, in the light beam deflection device provided by an embodiment of the present disclosure, the first liquid crystal layer includes twisted nematic liquid crystal.

For example, in the light beam deflection device provided by an embodiment of the present disclosure, the liquid crystal polarization grating includes: a third substrate; a fourth substrate, arranged opposite to the third substrate, wherein the second liquid crystal layer is located between the third substrate and the fourth substrate; a third alignment layer, located between the second liquid crystal layer and the third substrate; and a fourth alignment layer, located between the second liquid crystal layer and the fourth substrate.

For example, in the light beam deflection device provided by an embodiment of the present disclosure, the second substrate is located at a side of the first substrate away from the first side, and the fourth substrate is located at a side of the third substrate away from the first side, the second substrate and the third substrate are a same substrate.

For example, in the light beam deflection device provided by an embodiment of the present disclosure, the liquid crystal polarization grating includes: a third substrate; a fourth substrate, arranged opposite to the third substrate, wherein the second liquid crystal layer is located between the third substrate and the fourth substrate; a third alignment layer, located between the second liquid crystal layer and the third substrate; a fourth alignment layer, located between the second liquid crystal layer and the fourth substrate; a third transparent conductive layer, located between the third alignment layer and the third substrate; and a fourth transparent conductive layer, located between the fourth alignment layer and the fourth substrate, wherein the second driver includes the third transparent conductive layer and the fourth transparent conductive layer, in a case that a voltage signal between the third transparent conductive layer and the fourth transparent conductive layer is a third voltage, the second liquid crystal layer is in the third state, and in a case that the voltage signal between the third transparent conductive layer and the fourth transparent conductive layer is a fourth voltage, the second liquid crystal layer is in the fourth state.

For example, the light beam deflection device provided by an embodiment of the present disclosure, further includes: a controller, connected and in communication with a plurality of first drivers of the plurality of first light beam deflection structures and is configured to provide voltage signals to the plurality of first drivers to make the first liquid crystal layer in the first state or the second state.

At least one embodiment of the present disclosure provides a laser radar, including a laser emitting system, wherein the laser emitting system includes a plurality of lasers and any one of the above-mentioned light beam deflection devices, and the plurality of lasers are arranged corresponding to the light beam deflection device, the plurality of lasers are located at the first side of the light beam deflection device and are configured to emit light beams to the light beam deflection device.

For example, the laser radar provided by at least one embodiment of the present disclosure, further includes a laser receiving system, which includes a plurality of detectors, wherein the plurality of detectors are configured to receive light beams.

For example, in the laser radar provided by at least one embodiment of the present disclosure, the laser receiving system further includes the light beam deflection device, and the light beam deflection device is arranged corresponding to the plurality of detectors, the plurality of detectors are located at the first side of the light beam deflection device, and the plurality of detectors are configured to receive a light beam from the light beam deflection device.

### BRIEF DESCRIPTION OF DRAWINGS

In order to clearly illustrate the technical solution of the embodiments of the present disclosure, the drawings of the embodiments will be briefly described. It is obvious that the described drawings in the following are only related to some embodiments of the present disclosure and thus are not limitative of the present disclosure.

FIG. 1 is a schematic side view of a light beam deflection device provided by an embodiment of the present disclosure.

FIG. 2 is a schematic front view of a light beam deflection device illustrated by FIG. 1.

FIG. 3 is a schematic view of an optical path of a light beam deflection device illustrated by FIG. 1.

FIG. 4 is a schematic side view of another light beam deflection device provided by an embodiment of the present disclosure.

FIG. 5 is a diagram illustrating a corresponding relationship between states of first liquid crystal layers and deflection angles of outgoing light of the light beam deflection device illustrated by FIG. 4.

FIG. 6 is a schematic side view of another light beam deflection device provided by an embodiment of the present disclosure.

FIG. 7 is a diagram illustrating a corresponding relationship between states of first liquid crystal layers and the deflection angles of outgoing light of the light beam deflection device illustrated by FIG. 6.

FIG. 8 is a numerical diagram of the deflection angles of the outgoing light obtained by the light beam deflection device illustrated by FIG. 6.

FIG. 9 is a schematic side view of another light beam deflection device provided by an embodiment of the present disclosure.

FIG. 10 is a diagram illustrating a corresponding relationship between states of the first liquid crystal layer, states of the second liquid crystal layer and deflection angles of outgoing light of the light beam deflection device illustrated by FIG. 4.

FIG. 11 is a diagram illustrating a corresponding relationship between states of the first liquid crystal layer, states of a second liquid crystal layer and deflection angles of outgoing light of the light beam deflection device illustrated by FIG. 6.

FIG. 12A is a structural schematic diagram of another light beam deflection structure provided by an embodiment of the present disclosure.

FIG. 12B is a schematic front view of a liquid crystal polarization grating of a second light beam deflection structure illustrated by FIG. 12A.

FIG. 13 is a schematic structural diagram of a liquid crystal variable wave plate provided by an embodiment of the present disclosure.

FIG. 14 is a schematic diagram of a liquid crystal variable wave plate in a state of being applied with a first voltage according to an embodiment of the present disclosure.

FIGS. 15 and 16 are light beam simulation diagrams in the state illustrated by FIG. 14.

FIG. 17 is a schematic diagram of a liquid crystal variable wave plate in a state of being applied with a second voltage according to an embodiment of the present disclosure.

FIGS. 18 and 19 are light beam simulation diagrams in a state illustrated by FIG. 17.

FIG. 20 is a diagram illustrating a state of a first liquid crystal layer of another liquid crystal variable wave plate being applied with a first voltage according to an embodiment of the present disclosure.

FIG. 21 is a diagram illustrating a state of the first liquid crystal layer after a second voltage is applied to the liquid crystal variable wave plate illustrated by FIG. 20.

FIG. 22 is a schematic diagram illustrating a state of another liquid crystal variable wave plate being applied with a first voltage according to an embodiment of the present disclosure.

FIG. 23 is a schematic diagram illustrating a state of the liquid crystal variable wave plate illustrated by FIG. 22 under an application of a second voltage.

FIG. 24 is a schematic side view of a liquid crystal polarization grating according to an embodiment of the present disclosure.

FIG. 25 is a schematic top view of a second liquid crystal layer of a liquid crystal polarization grating illustrated by FIG. 24.

FIG. 26 is a schematic diagram illustrating a state of another liquid crystal polarization grating applied with a third voltage according to an embodiment of the present disclosure.

FIG. 27 is a schematic diagram illustrating a state of a liquid crystal polarization grating illustrated by FIG. 26 applied with a fourth voltage.

FIGS. 28 to 35 are light beam simulation diagrams of different grating periods in a state illustrated by FIG. 26.

FIG. 36 is a structural schematic diagram of a light beam deflection structure provided by an embodiment of the present disclosure.

FIGS. 37 and 38 are schematic diagrams illustrating light beam deflection of the light beam deflection structure illustrated by FIG. 36.

FIG. 39 is a structural schematic diagram of another light beam deflection structure provided by an embodiment of the present disclosure.

FIGS. 40 to 42 are schematic diagrams illustrating light beam deflection of the light beam deflection structure illustrated by FIG. 39.

FIG. 43 is a diagram illustrating corresponding relationship of voltage states of a first liquid crystal layer and deflection angles of outgoing light of a light beam deflection device illustrated by FIG. 4.

FIG. 44 is a diagram illustrating corresponding relationship of voltage states of liquid crystal layers and deflection angles of outgoing light of a light beam deflection device illustrated by FIG. 4.

FIG. 45 is a diagram illustrating corresponding relationship of voltage states of a first liquid crystal layer and deflection angles of outgoing light of a light beam deflection device illustrated by FIG. 6.

FIG. 46 is a diagram illustrating corresponding relationship of voltage states of liquid crystal layers and deflection angles of outgoing light of a light beam deflection device illustrated by FIG. 6.

FIG. 47 is a schematic diagram of another light beam deflection device provided by an embodiment of the present disclosure.

FIG. 48 is a process flow chart of forming a liquid crystal variable wave plate according to an embodiment of the present disclosure.

FIG. 49 is a process flow chart of forming a passive liquid crystal polarization grating provided by an embodiment of the present disclosure.

FIG. 50 is a process flow chart of forming an active liquid crystal polarization grating according to an embodiment of the present disclosure.

FIG. 51 is a schematic structural diagram of a laser emitting system of a laser radar provided by an embodiment of the present disclosure.

FIG. 52 is a schematic structural diagram of a laser receiving system provided by an embodiment of the present disclosure.

FIG. 53 is a structural schematic diagram of another laser receiving system provided by an embodiment of the present disclosure.

FIG. 54 is a working flow chart of a laser radar provided by an embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., used in the present disclosure are not intended to indicate any sequence, amount or importance, but distinguish different components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not limited to a physical connection or mechanical connection, but may also include an electrical connection, directly or indirectly.

Unless otherwise defined, the features of “parallel”, “vertical” and “identical” used in the embodiments of the present disclosure include the strict sense of “parallel”, “vertical” and “identical”, as well as the situations involving certain errors such as “substantially parallel”, “substantially vertical” and “substantially identical”. For example, the above-mentioned “substantially” can indicate that the difference value of the compared object is within 10% or 5% of the average value of the compared object. When the number of a component or element is not specifically indicated in the following embodiments of the present disclosure, it means that the component or element can be one or more, or can be understood as at least one. “At least one” refers to one or more, and “more than one” refers to at least two. The “arranged in the same layer” in the embodiments of the present disclosure refers to the relationship between multiple film layers formed by the same material after the same step (e.g., a one-step patterning process). Here, “in the same layer” does not always refer to the thickness of multiple film layers being the same or the height of multiple film layers being the same in the cross-sectional view.

Liquid crystal polarization grating can adjust a polarization state of incident light and realize light splitting effect by using the periodic arrangement of liquid crystal directors. Taking the periodic distribution of directors on the X axis as an example, the directors of liquid crystal molecules can be described as:

$$α = \frac{- π x}{Λ} + {α}_{0} ,$$

wherein, ∧ is the period of liquid crystal polarization grating, and do is the initial azimuth of liquid crystal.

Using Jones matrix to describe the transmittance T of liquid crystal polarization grating:

$$T = R ( - α ) [ \begin{matrix}1 & 0 \\ 0 & exp ( i Γ )\end{matrix} ] R ( α ) ,$$

wherein, rotation matrix

$$R ( α ) = [ \begin{matrix}cos α & - sin α \\ sin α & cos α\end{matrix} ] , Γ = \frac{2 π}{λ} Δ nd ,$$

Γ is the dynamic phase of light in liquid crystal, the transmittance T:

$$T = cos \frac{Γ}{2} [ \begin{matrix}1 & 0 \\ 0 & 1\end{matrix} ] - {ie}^{i 2 α} sin \frac{Γ}{2} [ \begin{matrix}1 & i \\ i & - 1\end{matrix} ] - {ie}^{- i 2 α} sin \frac{Γ}{2} [ \begin{matrix}1 & - i \\ - i & - 1\end{matrix} ] .$$

Using grating equation to calculate diffraction angle θ,

$$θ = \pm arc sin \frac{λ}{Λ} ,$$

λ is the wavelength of incident light, and ∧ is the period of liquid crystal polarization grating. Therefore, the preparation of liquid crystal polarization gratings with different deflection angles can be realized by changing the period of liquid crystal polarization gratings.

Wave plate, also known as phase retardation plate, can cause a phase shift between two orthogonal polarization components passing through the wave plate, and can be used to adjust a polarization state of light beam. Wave plate is a transparent plate with specific birefringence, and is usually used to control the polarization state of light beam. For example, a half-wave plate is a chip that can make the optical path difference between ordinary light (o light) and extraordinary light (e light) be ½ wavelength. Left-handed circularly polarized light passes through a half-wave plate and becomes right-handed circularly polarized light; right-handed circularly polarized light passes through a half-wave plate and becomes left-handed circularly polarized light.

A common wave plate in optical components is formed from quartz crystal, calcite (CaCO₃), magnesium fluoride (MgF2), sapphire (Al₂O₃), mica and some birefringent polymers, but the common wave plate is a fixed wave plate, which can not realize the switching of multiple polarizations.

The embodiment of the present disclosure provides a light beam deflection device and a laser radar. The light beam deflection device includes a light-entering side and a light-exiting side which are opposite in a first direction, and includes a light beam deflection structure, the light beam deflection structure includes a liquid crystal variable wave plate and a liquid crystal polarization grating. The liquid crystal variable wave plate includes a first liquid crystal layer and a first driver, the first liquid crystal layer includes a first state and a second state, the first driver is configured to drive the first liquid crystal layer to be in the first state or the second state, in the case that the first liquid crystal layer is in the first state, the liquid crystal variable wave plate is configured to change light of a first polarization state into light of a second polarization state or light of the second polarization state into light of the first polarization state, in the case that the first liquid crystal layer is in the second state, the liquid crystal variable wave plate is configured to not to change the polarization state of light. The liquid crystal polarization grating is arranged at a side of the liquid crystal variable wave plate away from the light-entering side, and includes a second liquid crystal layer, and the second liquid crystal layer includes a third state. In the third state, the liquid crystal polarization grating is configured to change the light of the first polarization state into the light of the second polarization state and deflect the light toward a first deflection direction by a set angle, or change the light of the second polarization state into the light of the first polarization state and deflect the light toward a second deflection direction by the set angle, and the first deflection direction and the second deflection direction are symmetrical with respect to a propagation direction of the light. The light beam deflection structure includes a first light beam deflection structure, the first deflection direction and the second deflection direction of the liquid crystal polarization grating in the first light beam deflection structure are located in a first plane where a first direction and a second direction are located, and the second direction is perpendicular to the first direction. The light beam deflection device includes a plurality of first light beam deflection structures which are arranged along the first direction.

In the light beam deflection device provided by the embodiment of the present disclosure, the light enters the light beam deflection device from a first side and exits from a second side of the light beam deflection device, and the liquid crystal variable wave plate can change the polarization state of the light, and the liquid crystal polarization grating can change the deflection direction and the deflection angle of the light according to the polarization state of the incident light. The liquid crystal variable wave plate is arranged at the first side of the liquid crystal polarization grating, by setting the state of the first liquid crystal layer of the liquid crystal variable wave plate, the polarization state of the light entering the liquid crystal polarization grating can be set, and then the deflection direction and deflection angle of the light can be set. The plurality of first light beam deflection structures are arranged along the first direction, and by setting the state of the first liquid crystal layer of the liquid crystal variable wave plate of each first light beam deflection structure, the deflection direction and the deflection angle of the light in the first plane after passing through each first light beam deflection structure can be set, and light with a plurality of different deflection directions and deflection angles can be combined and obtained after the light passing through the plurality of first light beam deflection structures, so that the light with different deflection directions and deflection angles can be obtained. For example, by setting the states of the first liquid crystal layers of the liquid crystal variable wave plates of the plurality of first light beam deflection structures, the light can be deflected toward the first deflection direction or the second deflection direction in the first plane after the light passing through each first light beam deflection structure, so that the light with a maximum deflection angle toward the first deflection direction or the light with a maximum deflection angle toward the second deflection direction can be obtained after the light passing through the plurality of first light beam deflection structures, and the maximum deflection angle is equal to the sum of the set angles of the plurality of first light beam deflection structures. Therefore, through the light beam deflection device, not only the light with the maximum deflection angle can be obtained, but also a plurality of light with different deflection angles can be obtained, the scanning of the light beam can be realized, so that the light beam can be scanned in one dimension in the first plane.

Hereinafter, the light beam deflection device and the laser radar provided by the embodiments of the present disclosure will be described in detail with reference to the accompanying drawings.

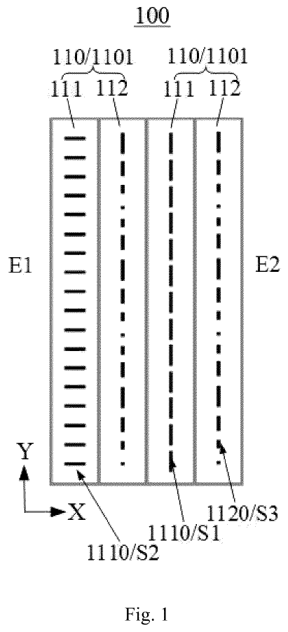

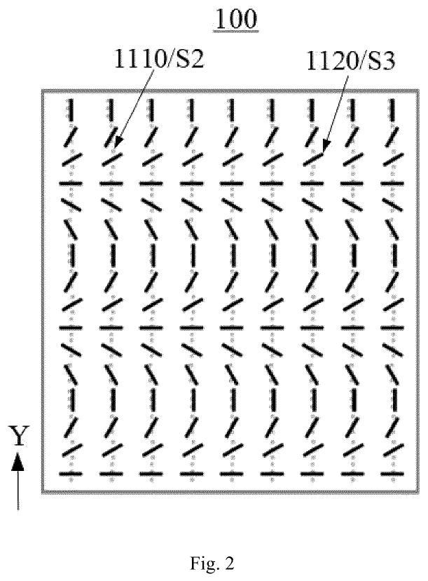

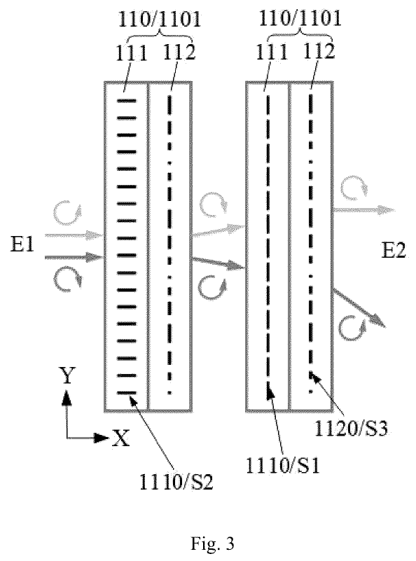

An embodiment of the present disclosure provides a light beam deflection device. FIG. 1 is a schematic side view of a light beam deflection device provided by an embodiment of the present disclosure; FIG. 2 is a schematic front view of a light beam deflection device illustrated by FIG. 1; FIG. 3 is a schematic view of an optical path of a light beam deflection device illustrated by FIG. 1. As illustrated by FIGS. 1 to 3, a light beam deflection device 100 includes a light beam deflection structure 110, the light beam deflection structure 110 includes a liquid crystal variable wave plate 111 and a liquid crystal polarization grating 112. The liquid crystal variable wave plate 111 includes a first liquid crystal layer 1110 and a first driver, the first liquid crystal layer 1110 includes a first state S1 and a second state S2, the first driver is configured to drive the first liquid crystal layer 1110 to be in the first state S1 or the second state S2. In the case that the first liquid crystal layer 1110 is in the first state S1, the liquid crystal variable wave plate 111 is configured to change light of a first polarization state into light of a second polarization state, or to change light of the second polarization state into light of the first polarization state. In the case that the first liquid crystal layer 1110 is in the second state S2, the liquid crystal variable wave plate 111 is configured not to change the polarization state of light. For example, in the case that the first liquid crystal layer 1110 is in the first state S1, the liquid crystal variable wave plate 111 is a half wave plate; in the case that the first liquid crystal layer 1110 is in the second state S2, the liquid crystal variable wave plate 111 is a full wave plate. The liquid crystal polarization grating 112 is arranged at a side of the liquid crystal variable wave plate 111 away from a first side E1, and includes a second liquid crystal layer 1120 which includes a third state S3, in the case that the second liquid crystal layer 1120 is in the third state S3, the liquid crystal polarization grating 112 is configured to change the light of the first polarization state into the light of the second polarization state and deflect the light toward a first deflection direction by a set angle, or change the light of the second polarization state into the light of the first polarization state and deflect the light toward a second deflection direction by a set angle, and the first deflection direction and the second deflection direction are symmetrical with respect to a propagation direction of the light.

The light beam deflection structure 110 includes a first light beam deflection structure 1101, the first deflection direction and the second deflection direction of the liquid crystal polarization grating 112 in the first light beam deflection structure 1101 are located in a first plane where a first direction X and a second direction Y are located, and the second direction Y is perpendicular to the first direction X. The light beam deflection device 100 includes a plurality of first light beam deflection structures 1101 which are arranged along the first direction X.

In the light beam deflection device 100 provided by the embodiment of the present disclosure, the light enters the light beam deflection device 100 from the first side E1 and exits from a second side E2 of the light beam deflection device 100, and the liquid crystal variable wave plate 111 can change the polarization state of the light, and the liquid crystal polarization grating 112 can change the deflection direction and the deflection angle of the light according to the polarization state of the incident light. The liquid crystal variable wave plate 111 is arranged at the first side E1 of the liquid crystal polarization grating 112, by setting the state of the first liquid crystal layer 1110 of the liquid crystal variable wave plate 111, the polarization state of the light entering the liquid crystal polarization grating 112 can be set, and then the deflection direction and deflection angle of the light can be set. A plurality of first light beam deflection structures 1101 are arranged along the first direction, and by setting the state of the first liquid crystal layer 1110 of the liquid crystal variable wave plate 111 of each first light beam deflection structure 1101, the deflection direction and the deflection angle in the first plane of the light after the light passing through each first light beam deflection structure 1101 can be set, and after the light passing through the plurality of first light beam deflection structures, a plurality of different deflection directions and deflection angles can be combined and obtained, so that the light with different deflection directions and deflection angles can be obtained.

For example, by setting the states of the first liquid crystal layers 1110 of the liquid crystal variable wave plates 111 of the plurality of first light beam deflection structures 1101, the light can be deflected toward the first deflection direction or the second deflection direction in the first plane after passing through each first light beam deflection structure 1101, so that light with a maximum deflection angle toward the first deflection direction or light with a maximum deflection angle toward the second deflection direction can be obtained after the light passing through the plurality of first light beam deflection structures 1101, and the maximum deflection angle is equal to the sum of the set angles of the plurality of first light beam deflection structures 1101.

For example, by setting the states of the first liquid crystal layers 1110 of the liquid crystal variable wave plates 111 of the plurality of first light beam deflection structures 1101, light that is located in the first plane and has a deflection angle between the maximum deflection angle toward the first deflection direction and the maximum deflection angle toward the second deflection direction can be obtained, and the deflection angle of the light can be calculated or combined by the set angles of deflection of the plurality of liquid crystal polarization gratings 112.

Therefore, through the light beam deflection device 100, not only the light with the maximum deflection angle can be obtained, but also a plurality of light with multiple different deflection angles can be obtained, the scanning of the light beams can be realized, so that one-dimensional scanning of light beam can be performed in the first plane. For example, a number of the light beam deflection structures 110 of the light beam deflection device 100 may be 2, 3 or 4, etc., and embodiments of the present disclosure are not limited thereto.

In some examples, as illustrated by FIG. 1, the first light beam deflection structures 1101 that are adjacent to each other in the first direction X may be attached to each other using a refractive index matching adhesive. For example, a thickness of the refractive index matching adhesive may be in a range from 200 nm to 2 μm. The thickness of the refractive index matching adhesive is related to the viscosity and density of the refractive index matching adhesive and the rotation speed of spin coater and is not limited by the present disclosure. Of course, the fixing mode of the adjacent first light beam deflection structures 1101 is not limited by the present disclosure, for example, a clamping fixing mode can also be adopted.

In some examples, as illustrated by FIGS. 1 and 2, a periodic arrangement direction of the liquid crystal directors of the second liquid crystal layer 1120 of the liquid crystal polarization grating 112 in the first light beam deflection structure 1101 is the second direction Y. The first direction X and the second direction Y form the first plane. For example, the first deflection direction may be a positive Y direction, and deflection toward the first deflection direction means a positive deflection toward the Y direction; the second deflection direction may be a negative Y direction, and deflection toward the second deflection direction means a negative deflection toward the Y direction. By setting the periodic arrangement direction of the liquid crystal directors of the liquid crystal polarization grating 112, the liquid crystal polarization grating 112 can adjust the polarization state of the incident light and change the deflection direction of the incident light by using the periodic arrangement of the liquid crystal directors. It should be noted that FIG. 2 schematically shows only one case of the second direction Y, and the periodic arrangement direction of the liquid crystal directors may be any direction perpendicular to the first direction X.

In some examples, as illustrated by FIG. 1, the first polarization state may be a right-handed circularly polarization state, and the second polarization state may be a left-handed circularly polarization state. For example, the first polarization state may be a left-handed circularly polarization state, and the second polarization state may be a right-handed circularly polarization state.

For example, in the case that the liquid crystal polarization grating 112 includes the second liquid crystal layer 1120 and the second liquid crystal layer 1120 only includes the third state S3, the liquid crystal polarization grating 112 may be called a passive liquid crystal polarization grating.

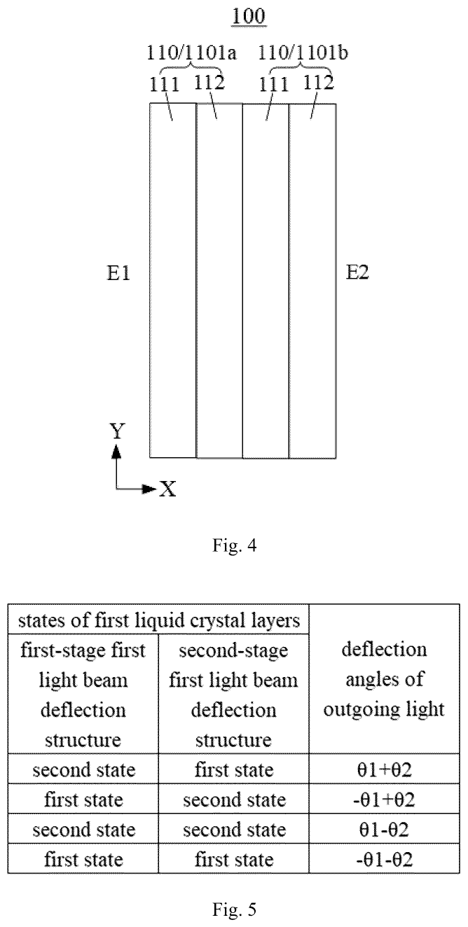

FIG. 4 is a schematic side view of another light beam deflection device provided by an embodiment of the present disclosure; FIG. 5 is a diagram illustrating a corresponding relationship between states of first liquid crystal layers and deflection angles of outgoing light of the light beam deflection device illustrated by FIG. 4. As illustrated by FIG. 4, the light beam deflection device 100 includes two first light beam deflection structures 1101, which are a first-stage first light beam deflection structure 1101a and a second-stage first light beam deflection structure 1101b, respectively. The set angle of deflection of the liquid crystal polarization grating 112 of the first-stage first light beam deflection structure 1101a is θ1, and the set angle of deflection of the liquid crystal polarization grating 112 of the second-stage first light beam deflection structure 1101b is θ2. For example, the liquid crystal polarization gratings 112 of the two first light beam deflection structures 1101 may be passive liquid crystal polarization gratings.

For example, as illustrated by FIGS. 4 and 5, in the case that the first liquid crystal layer 1110 of the liquid crystal variable wave plate 111 of the first-stage first light beam deflection structure 1101a is in the second state S2, and the first liquid crystal layer 1110 of the liquid crystal variable wave plate 111 of the second-stage first light beam deflection structure 1101b is in the first state S1, it is assumed that the light incident on the light beam deflection device is in the first polarization state, the polarization state of the light is not changed after the light of the first polarization state passing through the liquid crystal variable wave plate 111 of the first-stage first light beam deflection structure 1101a, and the light is deflected by an angle of θ1 in the first plane toward the first deflection direction and becomes the light of the second polarization state after passing through the liquid crystal polarization grating 112 of the first-stage first light beam deflection structure 1101a. The light of the second polarization state becomes the light of the first polarization state after passing through the liquid crystal variable wave plate 111 of the second-stage first light beam deflection structure 1101b, and then the light of the first polarization state is deflected by an angle of θ2 in the first plane toward the first deflection direction and becomes the light of the second polarization state after passing through the liquid crystal polarization grating 112 of the second-stage first light beam deflection structure 1101b. Therefore, the angle at which the light of the first polarization state is deflected toward the first deflection direction in the first plane is θ1+θ2 after passing through the light beam deflection device 100.

For example, as illustrated by FIGS. 4 and 5, in the case that the first liquid crystal layer 1110 of the liquid crystal variable wave plate 111 of the first-stage first light beam deflection structure 1101a is in the first state S1, and the first liquid crystal layer 1110 of the liquid crystal variable wave plate 111 of the second-stage first light beam deflection structure 1101b is in the second state S2, the light of the first polarization state becomes the light of the second polarization state after passing through the liquid crystal variable wave plate 111 of the first-stage first light beam deflection structure 1101a, and the light is then deflected by an angle of θ1 in the first plane toward the second deflection direction and becomes the light of the first polarization state after passing through the liquid crystal polarization grating 112 of the first-stage first light beam deflection structure 1101a. The first polarization state of the light is not changed after the light passing through the liquid crystal variable wave plate 111 of the second-stage first light beam deflection structure 1101b, and the light is then deflected by an angle of θ2 in the first plane toward the first deflection direction and becomes the light of the second polarization state after passing through the liquid crystal polarization grating 112 of the second-stage first light beam deflection structure 1101b. Therefore, the angle at which the light of the first polarization state is deflected toward the first deflection direction in the first plane is −θ1+θ2 after passing through the light beam deflection device 100. It should be noted that, the negative sign in front of θ1 indicates that the deflection direction is the second deflection direction, and the positive sign in front of θ1 indicates that the deflection direction is the first deflection direction. If the result of −θ1+θ2 is negative, it indicates that the deflection direction of the light is the second deflection direction, and if the result of −θ1+θ2 is positive, it indicates that the deflection direction of the light is the first deflection direction.

Similarly, the corresponding relationship illustrated by FIG. 5 can be obtained, which will not be described again here. After the light beam passing through the light beam deflection device 100, the maximum angle that can be deflected is ±(θ1+θ2), and a field of view angle of the light beam deflection device 100 is 2(θ1+θ2). The positive sign indicates that the deflection direction is the first deflection direction in the first plane, and the negative sign indicates that the deflection direction is the second deflection direction in the first plane. By setting the states of the two first liquid crystal layers 1110 of the light beam deflection device 100 respectively, the light with four different deflection angles can be obtained.

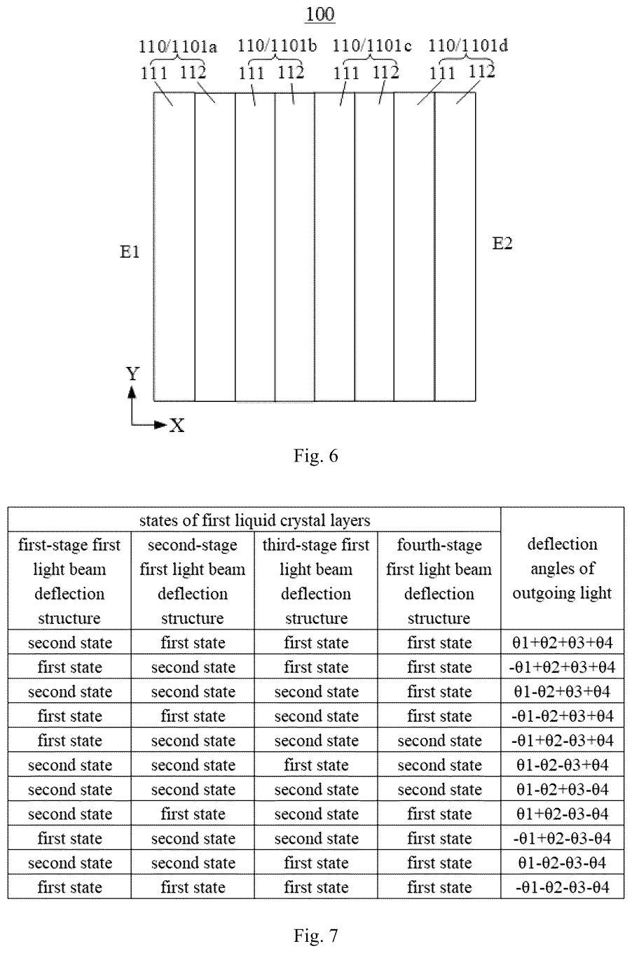

FIG. 6 is a schematic side view of another light beam deflection device provided by an embodiment of the present disclosure; FIG. 7 is a diagram illustrating a corresponding relationship between states of first liquid crystal layers and the deflection angles of outgoing light of the light beam deflection device illustrated by FIG. 6. As illustrated by FIGS. 6 and 7, the light beam deflection device 100 includes four first light beam deflection structures 1101, which are the first-stage first light beam deflection structure 1101a, the second-stage first light beam deflection structure 1101b, the third-stage first light beam deflection structure 1101c and the fourth-stage first light beam deflection structure 1101d, respectively. The set angle of deflection of the liquid crystal polarization grating 112 of the first-stage first light beam deflection structure 1101a is θ1, the set angle of deflection of the liquid crystal polarization grating 112 of the second-stage first light beam deflection structure 1101b is θ2, the set angle of deflection of the liquid crystal polarization grating 112 of the third-stage first light beam deflection structure 1101c is θ3, and the set angle of deflection of the liquid crystal polarization grating 112 of the fourth-stage first light beam deflection structure 1101d is θ4. For example, the liquid crystal polarization gratings 112 of the four first light beam deflection structures 1101 may be passive liquid crystal polarization gratings.

For example, as illustrated by FIGS. 6 and 7, in the case that the states of the first liquid crystal layers 1110 of the four first light beam deflection structures 1101 are the second state S2, the first state S1, the first state S1 and the first state S1 respectively, it is assumed that the light incident on the light beam deflection device 100 is in the first polarization state, the polarization state of the light is not changed after the light of the first polarization state passing through the liquid crystal variable wave plate 111 of the first-stage first light beam deflection structure 1101a, and the light is then deflected by an angle of θ1 in the first plane toward the first deflection direction and becomes the light of the second polarization state after passing through the liquid crystal polarization grating 112 of the first-stage first light beam deflection structure 1101a. The light of the second polarization state becomes the light of the first polarization state after passing through the liquid crystal variable wave plate 111 of the second-stage first light beam deflection structure 1101b, and then the light of the first polarization state is deflected by an angle of θ2 in the first plane toward the first deflection direction and becomes the light of the second polarization state after passing through the liquid crystal polarization grating 112 of the second-stage first light beam deflection structure 1101b, and the light of the second polarization state becomes the light of the first polarization state after passing through the liquid crystal variable wave plate 111 of the third-stage first light beam deflection structure 1101c, the light is then deflected by an angle of θ3 in the first plane toward the first deflection direction and becomes the light of the second polarization state after passing through the liquid crystal polarization grating 112 of the third-stage first light beam deflection structure 1101c, the light of the second polarization state becomes the light of the first polarization state after passing through the liquid crystal variable wave plate 111 of the fourth-stage first light beam deflection structure 1101d, and the light is then deflected by an angle of θ4 in the first plane toward the first deflection direction and becomes the light of the second polarization state after passing through the liquid crystal polarization grating 112 of the fourth-stage first light beam deflection structure 1101d. As such, the angle at which the light of the first polarization state is deflected toward the first deflection direction in the first plane is θ1+θ2+θ3+θ4 after passing through the light beam deflection device 100.

Similarly, the corresponding relationship illustrated by FIG. 7 can be obtained, which will not be described in further detail here. After the light beam passing through the light beam deflection device 100, the maximum angle that can be deflected is ±(θ1+θ2+θ3+θ4), and the field of view angle of the light beam deflection device 100 is 2(θ1+θ2+θ3+θ4). The positive sign indicates that the deflection direction is the first deflection direction in the first plane, and the negative sign indicates that the deflection direction is the second deflection direction in the first plane. By setting the states of the four first liquid crystal layers 1110 of the light beam deflection device 100 respectively, light with a plurality of different deflection angles as illustrated by FIG. 7 can be obtained. It should be noted that the state of the first liquid crystal layer 1110 illustrated by FIG. 7 is not unique, and the same deflection angle of the light exited from the light beam deflection device 100 can correspond to different states, which is not limited here.

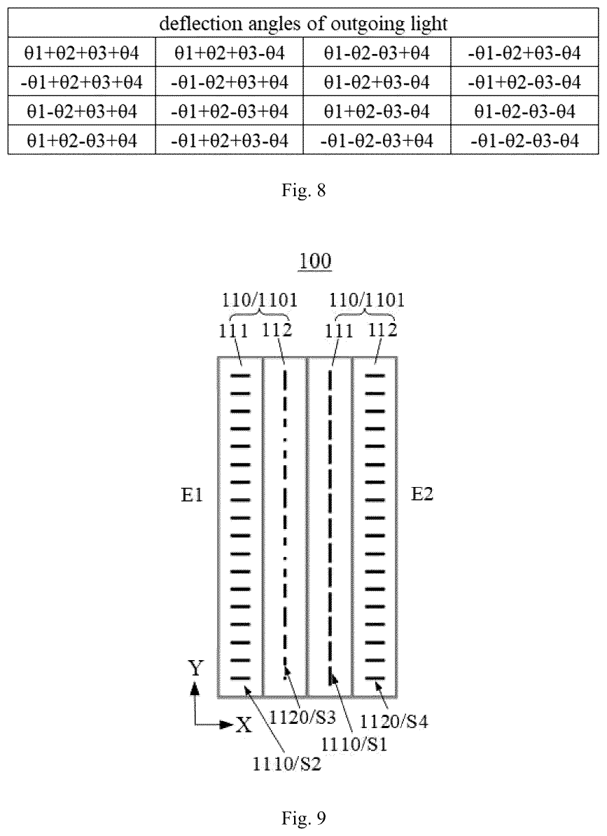

FIG. 8 is a numerical diagram of the deflection angles of the outgoing light obtained by the light beam deflection device illustrated by FIG. 6. As illustrated by FIG. 8, by setting the state of the first liquid crystal layer 1110 of the liquid crystal variable wave plate 111, the polarization state of the light entering the liquid crystal polarization grating 112 can be set, and then the deflection direction and deflection angle of light can be set. The deflection angles of the four liquid crystal polarization gratings 112 are ±θ1, ±θ2, ±θ3 and ±θ4, respectively. According to the calculation formulas of permutation and combination, the possible cases of the four liquid crystal polarization gratings 112 are combined respectively, and 2*2*2=16 cases can be obtained. For example, there may be cases in which the deflection angles of the obtained light are the same among the 16 cases.

In some examples, in the case that the set angles of the light beam deflection device 100 using the passive liquid crystal polarization gratings are all different, the light beam deflection device 100 can obtain more deflection angles. As illustrated by FIG. 5, in the case that the set angles θ1 and θ2 are different, the light beam deflection device 100 can obtain four different deflection angles. However, in the case that the set angles θ1 and θ2 are the same, the light beam deflection device 100 can only obtain two different deflection angles. As illustrated by FIG. 8, in the case that the set angles θ1, θ2, θ3 and θ4 are all different, the light beam deflection device 100 can obtain at most 16 different deflection angles, and in the case that at least any two set angles are the same, the number of the deflection angles obtained by the light beam deflection device 100 are less than the number of the deflection angles in the case that all four set angles are different.

In some examples, numerical values of the plurality of set angles of the light beam deflection device 100 using the passive liquid crystal polarization gratings may form an arithmetic sequence or a geometric sequence. Of course, the embodiment of the present disclosure does not limit the relationship between the numerical values of the plurality of set angles.

For example, as illustrated by FIG. 8, take an example that the four set angles may be θ, 2θ, 3θ and 4θ respectively, eleven different deflection angles can be obtained by bringing the four set angles into the formula in the figure for calculation, and are ±10θ, ±8θ, ±6θ, ±4θ, ±2θ and 0 respectively, and the eleven different deflection angles are evenly distributed. Therefore, in the case that the plurality of set angles form an arithmetic sequence, not only more deflection angles can be obtained, but also the obtained deflection angles are evenly distributed between the maximum deflection angles (±10θ) in two different deflection directions. For example, the light beam deflection device 100 can be used in products requiring uniform distribution of deflection angles.

For example, as illustrated by FIG. 8, taking an example that the four set angles may be θ, 2θ, 4θ and 8θ respectively, fourteen different deflection angles can be obtained by bringing the four set angles into the formula in the figure for calculation, and are ±15θ, ±13θ, ±11θ, ±9θ, ±7θ, ±5θ, ±3θ and ±θ respectively. Therefore, in the case that the plurality of set angles form a geometric sequence, not only more deflection angles can be obtained, but also the obtained deflection angles are evenly distributed between the maximum deflection angles (±15θ) in two different deflection directions.

FIG. 9 is a schematic side view of another light beam deflection device provided by an embodiment of the present disclosure. As illustrated by FIG. 9, the liquid crystal polarization grating 112 further includes a second driver, and the second liquid crystal layer 1120 further includes a fourth state S4, the second driver is configured to drive the second liquid crystal layer 1120 to be in the third state S3 or the fourth state S4, and in the fourth state S4, the liquid crystal polarization grating 112 is configured not to change the polarization state of light and the deflection angle of light.

In this example, the second liquid crystal layer 1120 of the liquid crystal polarization grating 112 includes two states, the two states can be adjusted by the second driver, so that in the case that the light beam deflection device 100 includes the same number of first light beam deflection structures 1101, compared with the case that the second liquid crystal layer 1120 of the liquid crystal polarization grating 112 only includes the third state S3, by setting the states of the second liquid crystal layer 1120 of the liquid crystal polarization grating 112,light with more different deflection directions and deflection angles can be combined and obtained after the light passing through the same number of first light beam deflection structures 1101, so that more light with different deflection directions and deflection angles can be obtained. In addition, because the second liquid crystal layer 1120 of the liquid crystal polarization grating 112 further includes the fourth state S4, the set angles of the plurality of liquid crystal polarization gratings 112 of the plurality of first light beam deflection structures 1101 can have a wider range of values.

For example, in the case that the liquid crystal polarization grating 112 includes a second liquid crystal layer 1120 and the second driver, and the second liquid crystal layer 1120 includes the third state S3 and the fourth state S4, the liquid crystal polarization grating 112 may be referred to as an active liquid crystal polarization grating 112b.

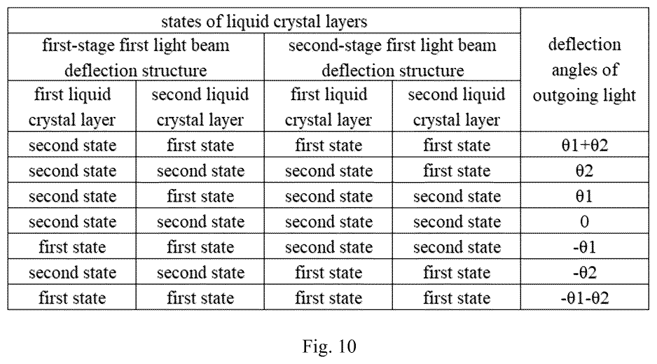

FIG. 10 is a diagram illustrating a corresponding relationship of states of the first liquid crystal layers and states of the second liquid crystal layers and deflection angles of outgoing light of the light beam deflection device 100. As illustrated by FIGS. 4 and 10, the light beam deflection device 100 includes two first light beam deflection structures 1101. For example, the liquid crystal polarization gratings 112 of the two first light beam deflection structures 1101 may be active liquid crystal polarization gratings.

For example, as illustrated by FIGS. 4 and 10, in the case that the first liquid crystal layer 1110 of the first-stage first light beam deflection structure 1101a is in the second state S2 and the second liquid crystal layer 1120 of the first-stage first light beam deflection structure 1101a is in the first state S1, and the first liquid crystal layer 1110 of the second-stage first light beam deflection structure 1101b is in the first state S1, and the second liquid crystal layer 1120 of the second-stage first light beam deflection structure 1101b is in the first state S1, it is assumed that the light incident on the light beam deflection device is in the first polarization state, the polarization state of the light is not changed after the light of the first polarization state passing through the liquid crystal variable wave plate 111 of the first-stage first light beam deflection structure 1101a, and the light is deflected by an angle of θ1 in the first plane toward the first deflection direction and becomes the light of the second polarization state after passing through the liquid crystal polarization grating 112 of the first-stage first light beam deflection structure 1101a. The light of the second polarization state becomes the light of the first polarization state after passing through the liquid crystal variable wave plate 111 of the second-stage first light beam deflection structure 1101b, and the light of the first polarization state is then deflected by an angle of θ2 in the first plane toward the first deflection direction and becomes the light of the second polarization state after passing through the liquid crystal polarization grating 112 of the second-stage first light beam deflection structure 1101b. As such, the angle at which the light of the first polarization state is deflected toward the first deflection direction in the first plane is θ1+θ2 after passing through the light beam deflection device 100.

For example, as illustrated by FIGS. 4 and 10, in the case that the first liquid crystal layer 1110 of the first-stage first light beam deflection structure 1101a is in the second state S2 and the second liquid crystal layer 1120 of the first-stage first light beam deflection structure 1101a is in the second state S2, and the first liquid crystal layer 1110 of the second-stage first light beam deflection structure 1101b is in the second state S2, and the second liquid crystal layer 1120 of the liquid crystal polarization grating 112 of the second-stage first light beam deflection structure 1101b is in the first state S1, the polarization state of the light is not changed after the light of the first polarization state passing through the liquid crystal variable wave plate 111 of the first-stage first light beam deflection structure 1101a, the polarization state and the deflection angle of the light are not changed after the light passing through the liquid crystal polarization grating 112 of the first-stage first light beam deflection structure 1101a. The polarization state of the light is not changed after the light of the first polarization state passing through the liquid crystal variable wave plate 111 of the second-stage first light beam deflection structure 1101b, and the light of the first polarization state is deflected by an angle of θ2 in the first plane toward the first deflection direction and becomes the light of the second polarization state after passing through the liquid crystal polarization grating 112 of the second-stage first light beam deflection structure 1101b. As such, the angle at which the light of the first polarization state is deflected toward the first deflection direction in the first plane after passing through the light beam deflection device 100 is 02.

Similarly, the corresponding relationship illustrated by FIG. 10 can be obtained, which will not be described in further detail here. After the light beam passing through the light beam deflection device 100, the maximum angle that can be deflected is ±(θ1+θ2), and the field of view angle of the light beam deflection device 100 is 2(θ1+θ2). The positive sign indicates that the deflection direction is the first deflection direction in the first plane, and the negative sign indicates that the deflection direction is the second deflection direction in the first plane. By setting the states of the first liquid crystal layer 1110 and the second liquid crystal layer 1120 of the light beam deflection device 100 respectively, light with a plurality of different deflection angles as illustrated by FIG. 10 can be obtained. It should be noted that the states of the first liquid crystal layer 1110 and the second liquid crystal layer 1120 illustrated by FIG. 10 are not unique, and the same deflection angle of the light exited from the light beam deflection device 100 can correspond to different states, which is not limited here.

For example, as illustrated by FIG. 4, in the case that the states of the second liquid crystal layers 1120 of the two active liquid crystal polarization gratings are in the third state S3, the light beam deflection device 100 using the active liquid crystal polarization grating is equivalent to the light beam deflection device 100 using the passive liquid crystal polarization grating. In addition, the light beam deflection device 100 using the active liquid crystal polarization grating 112b can realize the deflection angles illustrated by FIG. 10, that is to say, the light beam deflection device 100 using the active liquid crystal polarization grating can realize all the deflection angles illustrated by FIG. 5 and FIG. 10. Therefore, the light beam deflection device 100 using the active liquid crystal polarization grating can realize more deflection angles than the light beam deflection device 100 using the passive liquid crystal polarization grating.

For example, in the case that the light beam deflection device 100 includes two first light beam deflection structures 1101, the light beam deflection device 100 using the active liquid crystal polarization grating can obtain at most five more deflection angles than the light beam deflection device 100 using the passive liquid crystal polarization grating.

FIG. 11 is a diagram illustrating a corresponding relationship of states of the first liquid crystal layer and states of a second liquid crystal layer and deflection angles of outgoing light of the light beam deflection device. As illustrated by FIG. 6, the light beam deflection device 100 includes four first light beam deflection structures 1101. For example, the liquid crystal polarization gratings 112 of the four first light beam deflection structures 1101 may be the active liquid crystal polarization gratings 112b.

For example, as illustrated by FIGS. 6 and 11, in the case that the states of the first liquid crystal layers 1110 of the four first light beam deflection structures 1101 are the second state S2, the first state S1, the first state S1 and the first state S1, and the states of the second liquid crystal layers 1120 are all the first state S1, it is assumed that the light incident on the light beam deflection device is in the first polarization state, the polarization state of the light is not changed after the light of the first polarization state passing through the liquid crystal variable wave plate 111 of the first-stage first light beam deflection structure 1101a, the light is then deflected by an angle of θ1 in the first plane toward the first deflection direction and becomes the light of the second polarization state after passing through the liquid crystal polarization grating 112 of the first-stage first light beam deflection structure 1101a. The light of the second polarization state becomes the light of the first polarization state after passing through the liquid crystal variable wave plate 111 of the second-stage first light beam deflection structure 1101b, and the light is deflected by an angle of θ2 in the first plane toward the first deflection direction and becomes the light of the second polarization state after passing through the liquid crystal polarization grating 112 of the second-stage first light beam deflection structure 1101b. The light of the second polarization state becomes the light of the first polarization state after passing through the liquid crystal variable wave plate 111 of the third-stage first light beam deflection structure 1101c, the light is then deflected by an angle of θ3 in the first plane toward the first deflection direction and becomes the light of the second polarization state after passing through the liquid crystal polarization grating 112 of the third-stage first light beam deflection structure 1101c. The light of the second polarization state becomes the light of the first polarization state after passing through the liquid crystal variable wave plate 111 of the fourth-stage first light beam deflection structure 1101d, the light is then deflected by an angle of θ4 in the first plane toward the first deflection direction and becomes the light of the second polarization state after passing through the liquid crystal polarization grating 112 of the fourth-stage first light beam deflection structure 1101d. As such, the angle at which the light of the first polarization state is deflected in the first deflection direction in the first plane after passing through the light beam deflection device 100 is θ1+θ2+θ3+θ4.

Similarly, the corresponding relationship illustrated by FIG. 11 can be obtained, which will not be described in further detail here. After the light beam passing through the light beam deflection device 100, the maximum angle that can be deflected is ±(θ1+θ2+θ3+θ4), and the field of view angle of the light beam deflection device 100 is 2(θ1+θ2+θ3+θ4). The positive sign indicates that the deflection direction is the first deflection direction in the first plane, and the negative sign indicates that the deflection direction is the second deflection direction in the first plane. By setting the states of four first liquid crystal layers 1110 and four second liquid crystal layers 1120 of the light beam deflection device 100 respectively, light with a plurality of different deflection angles as illustrated by figure can be obtained. It should be noted that the states of the first liquid crystal layer 1110 and the second liquid crystal layer 1120 illustrated by figure are not unique, and the same deflection angle of the light exited from the light beam deflection device 100 can correspond to different states, which is not limited here.

In some examples, by setting the state of the second liquid crystal layer 1120, the active liquid crystal polarization grating 112b can be made not to change the polarization state and deflection angle of the light, so that the light beam deflection device 100 including the four first light beam deflection structures 1101 can obtain various deflection angles.

For example, in the case that the states of the four second liquid crystal layers 1120 of the light beam deflection device 100 are all in the third state S3, the deflection angle of the outgoing light obtained by the light beam deflection device 100 is equivalent to the deflection angle of the outgoing light obtained by the light beam deflection device 100 including four first light beam deflection structures 1101 whose liquid crystal polarization gratings 112 are all the passive liquid crystal polarization gratings. For example, the light beam deflection device 100 can obtain the deflection angles illustrated by FIG. 8.

For example, in the case that one of the four second liquid crystal layers 1120 of the light beam deflection device 100 is in the fourth state S4, the deflection angle of the outgoing light obtained by the light beam deflection device 100 is equivalent to the deflection angle of the outgoing light obtained by the light beam deflection device 100 including three first light beam deflection structures 1101 whose liquid crystal polarization gratings 112 are all the passive liquid crystal polarization gratings.

For example, in the case that two of the four second liquid crystal layers 1120 of the light beam deflection device 100 are in the fourth state S4, the deflection angle of the outgoing light obtained by the light beam deflection device 100 is equivalent to the deflection angle of the outgoing light obtained by the light beam deflection device 100 including two first light beam deflection structures 1101 of which the liquid crystal polarization gratings 112 are all the passive liquid crystal polarization gratings. For example, the light beam deflection device 100 can obtain the deflection angles illustrated by FIG. 5.

For example, in the case that three of the four second liquid crystal layers 1120 of the light beam deflection device 100 are in the fourth state S4, the deflection angle of the outgoing light obtained by the light beam deflection device 100 is equivalent to the deflection angle of the outgoing light obtained by the light beam deflection device 100 including one first light beam deflection structure 1101 of which the liquid crystal polarization grating 112 is the passive liquid crystal polarization grating.

For example, in the case that four of the four second liquid crystal layers 1120 of the light beam deflection device 100 are in the fourth state S4, the light beam deflection device 100 does not deflect the light.

Therefore, the light beam deflection device 100 that includes four first light beam deflection structures 1101 whose liquid crystal polarization gratings 112 are active liquid crystal polarization gratings can realize the above five cases, and all deflection angles obtained in the above five cases can be obtained. FIG. 11 only shows a part of the deflection angles of the outgoing light and the corresponding states of the first liquid crystal layer 1110 and the second liquid crystal layer 1120, and not all of them are shown one by one.

In some examples, a plurality of the set angles of the light beam deflection device 100 using the active liquid crystal polarization grating may be the same or different, and embodiments of the present disclosure are not limited thereto. Because the light beam deflection device 100 using the active liquid crystal polarization grating can obtain more deflection angles by setting the states of the first liquid crystal layer 1110 and the second liquid crystal layer 1120, the light beam deflection device 100 using the active liquid crystal polarization grating has low requirements on the set angles, which can have a wider range of values.

For example, the plurality of set angles of the light beam deflection device 100 using the active liquid crystal polarization grating may form an arithmetic sequence or a geometric sequence, or at least two set angles may be the same.

For example, as illustrated by FIG. 11, take an example that four set angles may be θ, 2θ, 3θ and 4θ respectively, by setting the first liquid crystal layers 1110 and the second liquid crystal layers 1120 in different states, the light beam deflection device 100 using the active liquid crystal polarization gratings 112b can obtain a total of 21 different deflection angles including ±10θ, ±9θ, ±8θ, ±7θ, ±6θ, ±5θ, ±4θ, ±3θ, ±2θ, ±θ and 0.

For example, as illustrated by FIG. 11, take an example that four set angles may be θ, 2θ, 4θ and 8θ respectively, by setting the first liquid crystal layers 1110 and the second liquid crystal layers 1120 in different states, the light beam deflection device 100 using the active liquid crystal polarization gratings 112b can obtain a total of 31 different deflection angles including ±15θ, ±14θ, ±13θ, ±12θ, ±11θ, ±10θ, ±9θ, ±8θ, ±7θ, ±6θ, ±5θ, ±4θ, ±3θ, ±2θ, ±θ and 0.

For example, as illustrated by FIG. 11, take an example that four set angles may be θ, 2θ, 4θ and 4θ respectively, by setting the first liquid crystal layers 1110 and the second liquid crystal layers 1120 in different states, the light beam deflection device 100 using the active liquid crystal polarization gratings 112b can obtain a total of 23 different deflection angles including ±11θ, ±10θ, ±9θ, ±8θ, ±7θ, ±6θ, ±5θ, ±4θ, ±3θ, ±2θ, ±1θ and 0.

In some examples, as illustrated by FIGS. 1, 4 and 6, the set angles of the liquid crystal polarization gratings 112 of the plurality of first light beam deflection structures 1101 are arranged in an order from small to large along a direction from the first side E1 of the light beam deflection device 100 pointing to the second side E2 of the light beam deflection device 100, so that the influence of the liquid crystal polarization gratings 112 on the diffraction efficiency reduction can be reduced.

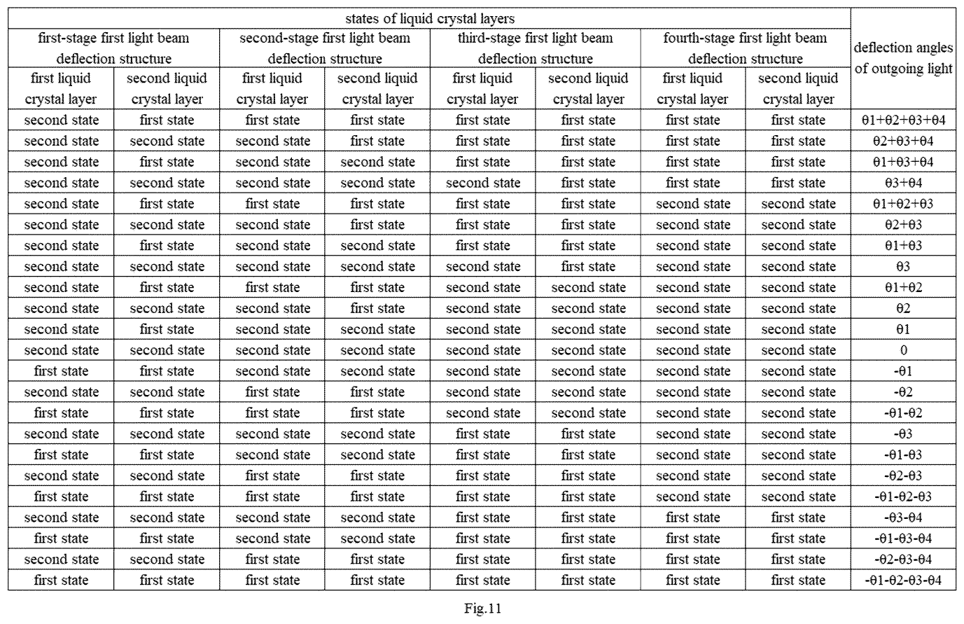

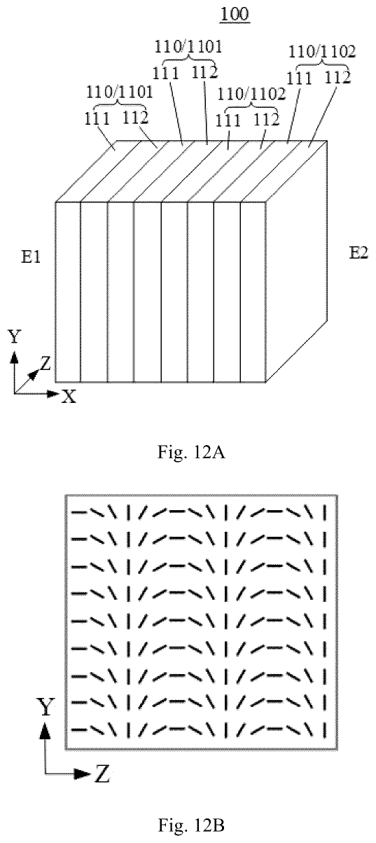

FIG. 12A is a structural schematic diagram of another light beam deflection structure provided by an embodiment of the present disclosure. As illustrated by FIG. 12A, the light beam deflection structure 110 includes a first light beam deflection structure 1101 and a second light beam deflection structure 1102. The first deflection direction and the second deflection direction of the liquid crystal polarization grating 112 of the second light beam deflection structure 1102 are located in a second plane where the first direction X and a third direction Z are located, and the third direction Z is perpendicular to both the first direction X and the second direction Y. The light beam deflection device 100 includes at least one second light beam deflection structure 1102, and the plurality of first light beam deflection structures 1101 and the at least one second light beam deflection structure 1102 are arranged along the first direction X. The light beam deflection device 100 can realize the deflection of the light in the first plane through the plurality of first light beam deflection structures 1101, and can further realize the deflection of the light in the second plane through the at least one second light beam deflection structure 1102, so that the light beam deflection device 100 can realize the scanning of the light beam in two planes and realize the two-dimensional scanning of the light beam.

In some examples, as illustrated by FIG. 12A, the at least one second light beam deflection structure 1102 of the light beam deflection device 100 is located at a side of the plurality of first light beam deflection structures 1101 away from the first side E1. Of course, the present disclosure is not limited thereto, and the at least one second light beam deflection structure 1102 of the light beam deflection device 100 may also be located at a side of the plurality of first light beam deflection structures 1101 away from the second side E2.

In some examples, as illustrated by FIG. 12A, a periodic arrangement direction of the liquid crystal directors of the second liquid crystal layer 1120 of the second light beam deflection structure 1102 is the third direction Z.

In some examples, as illustrated by FIG. 12A, the light beam deflection device 100 may include a plurality of second light beam deflection structures 1102 arranged in the first direction X. The plurality of second light beam deflection structures 1102 can obtain a relatively large deflection angle, and a plurality of different deflection angles can be obtained by setting the states of the first liquid crystal layers 1110 or the second liquid crystal layers 1120. FIG. 12A schematically illustrates that the light beam deflection structure 110 includes two first light beam deflection structures 1101 and two second light beam deflection structures 1102, but the embodiment of the present disclosure is not limited thereto.

In some examples, the change of the angle deflection and polarization state by the second light beam deflection structure 1102 of the light beam deflection device 100 can be referred to those described above with respect to the first light beam deflection structure 1101, and will not be repeated here.

FIG. 12B is a schematic front view of a liquid crystal polarization grating of the second light beam deflection structure illustrated by FIG. 12A. As illustrated by FIGS. 12A and 12B, the periodic arrangement direction of the liquid crystal directors of the second liquid crystal layer 1120 of the liquid crystal polarization grating 112 of the second light beam deflection structure 1102 is the third direction Z. The first direction X and the third direction Z form the second plane. For example, the periodic arrangement direction of the liquid crystal directors of the second liquid crystal layer 1120 of the liquid crystal polarization grating 112 of the first light beam deflection structure 1101 illustrated by FIG. 12A is the second direction Y, and can refer to FIG. 2 for details.

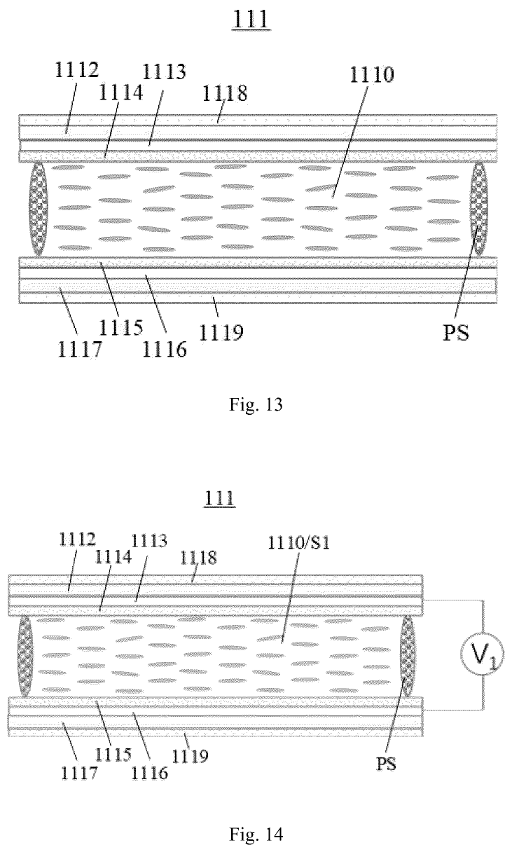

FIG. 13 is a schematic structural diagram of a liquid crystal variable wave plate provided by an embodiment of the present disclosure. As illustrated by FIG. 13, the liquid crystal variable wave plate 111 includes a first substrate 1112, a second substrate 1117, a first alignment layer 1114, a second alignment layer 1115, a first transparent conductive layer 1113, a second transparent conductive layer 1116 and a first liquid crystal layer 1110. The second substrate 1117 is arranged opposite to the first substrate 1112, and the first liquid crystal layer 1110 is located between the first substrate 1112 and the second substrate 1117. The first alignment layer 1114 is located between the first liquid crystal layer 1110 and the first substrate 1112, and the second alignment layer 1115 is located between the first liquid crystal layer 1110 and the second substrate 1117. The first transparent conductive layer 1113 is located between the first alignment layer 1114 and the first substrate 1112, and the second transparent conductive layer 1116 is located between the second alignment layer 1115 and the second substrate 1117.

The first driver includes the first transparent conductive layer 1113 and the second transparent conductive layer 1116, in the case that a voltage signal between the first transparent conductive layer 1113 and the second transparent conductive layer 1116 is a first voltage V1, the first liquid crystal layer 1110 is in the first state S1, in the case that the voltage signal between the first transparent conductive layer 1113 and the second transparent conductive layer 1116 is a second voltage V2, the first liquid crystal layer 1110 is in the second state S2. As such, changes between the first state S1 and the second state S2 of the first liquid crystal layer 1110 can be achieved by applying different voltage signals, and the liquid crystal variable wave plate 111 can be switched between the full wave plate and the half wave plate, so that the polarization state of the light beam can be changed or maintained.

In some examples, the alignment directions of liquid crystal molecules of the first liquid crystal layer 1110 are consistent, and a thickness of the first liquid crystal layer 1110 may be in a range from 2 μm to 5 μm.

In some examples, the first alignment layer 1114 and the second alignment layer 1115 may be formed by a rubbing alignment process or a photo-controlled alignment process. For example, polyimide (PI) is commonly used in the rubbing alignment process, azobenzene (SD1), polyethylene 4-methoxycinnamate (PVMC) and photosensitive polyimide or the like are commonly used in the photo-controlled alignment process. Thicknesses of the first alignment layer 1114 and the second alignment layer 1115 may each be in a range from 100 μm to 500 μm.

In some examples, thicknesses of the first transparent conductive layer 1113 and the second transparent conductive layer 1116 may each be in a range from 500 nm to 2 μm. For example, materials of the first transparent conductive layer 1113 and the second transparent conductive layer 1116 may be indium tin oxide (ITO) or the like.

In some examples, the first substrate 1112 and the second substrate 1117 may be high-transparent glass. For example, a transmittance of the high-transmittance glass for light with a wavelength ranging from 850 nm to 1550 nm is greater than or equal to 95%. Thus, a transmittance of the light incident on the liquid crystal variable wave plate 111 can be increased. For example, thicknesses of the first substrate 1112 and the second substrate 1117 may each be in a range from 100 μm to 700 μm.

In some examples, as illustrated by FIG. 13, the liquid crystal variable wave plate 111 may further include a first antireflection film 1118 and a second antireflection film 1119. The first antireflection film 1118 is located on a side of the first substrate 1112 away from the first transparent conductive layer 1113, and the second antireflection film 1119 is located on a side of the second substrate 1117 away from the second transparent conductive layer 1116. The first antireflection film 1118 and the second antireflection film 1119 can decrease the reflection of the light beam and increase the transmission of the light beam, thereby increasing the transmittance of the light incident on the liquid crystal variable wave plate 111. For example, thicknesses of the first antireflection film 1118 and the second antireflection film 1119 may each be in a range from 200 nm to 1 μm.

In some examples, as illustrated by FIG. 13, the liquid crystal variable wave plate 111 may further include a plurality of isolation columns PS located between the first substrate 1112 and the second substrate 1117 to support the first substrate 1112 and the second substrate 1117 and seal the first liquid crystal layer 1110. For example, the isolation column PS may be frame sealing adhesive mixed with polystyrene beads, and a diameter of the isolation column PS is consistent with a cell thickness of the liquid crystal cell to have the effect of providing support and evening the cell thickness.

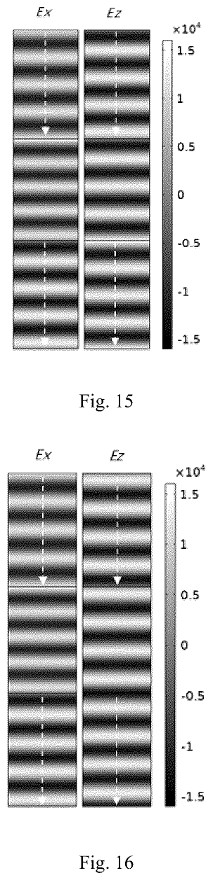

FIG. 14 is a schematic diagram of a liquid crystal variable wave plate under an application of a first voltage according to an embodiment of the present disclosure; FIGS. 15 and 16 are light beam simulation diagrams in the state illustrated by FIG. 14. As illustrated by FIG. 14, in the case that the first liquid crystal layer 1110 adopts nematic liquid crystal, the liquid crystal variable wave plate 111 is called nematic liquid crystal variable wave plate. The thickness of the first liquid crystal layer 1110 of the nematic liquid crystal variable wave plate is set to be d=λ/2Δn, λ is the wavelength of the incident light, and Δn is a refractive index difference of the liquid crystal.

For example, as illustrated by FIG. 14, in the case that the first voltage V1 applied between the first transparent conductive layer 1113 and the second transparent conductive layer 1116 of the nematic liquid crystal variable wave plate is 0 V, the liquid crystal of the first liquid crystal layer 1110 is not deflected, and the first liquid crystal layer 1110 is in the first state S1. In this case, the nematic liquid crystal variable wave plate is the half wave plate.

For example, as illustrated by FIG. 15, in the case that the incident light incident on the nematic liquid crystal variable wave plate is left-handed circularly polarized light, the light exited from the nematic liquid crystal variable wave plate is right-handed circularly polarized light. As illustrated by FIG. 16, in the case that the incident light incident on the nematic liquid crystal variable wave plate is right-handed circularly polarized light, the light exited from the nematic liquid crystal variable wave plate is left-handed circularly polarized light. In FIGS. 15 and 16, Ex represents an electric field in the X direction, Ez represents an electric field in the Z direction, and the light propagates in the Y direction, in the process of propagating in the Y direction, the light has electric fields along the X direction and the Z direction, and the light is circularly polarized light. Ex and Ez in the light beam simulation diagram in this disclosure are the same as those in FIG. 15 and FIG. 16, and will not be described again here.

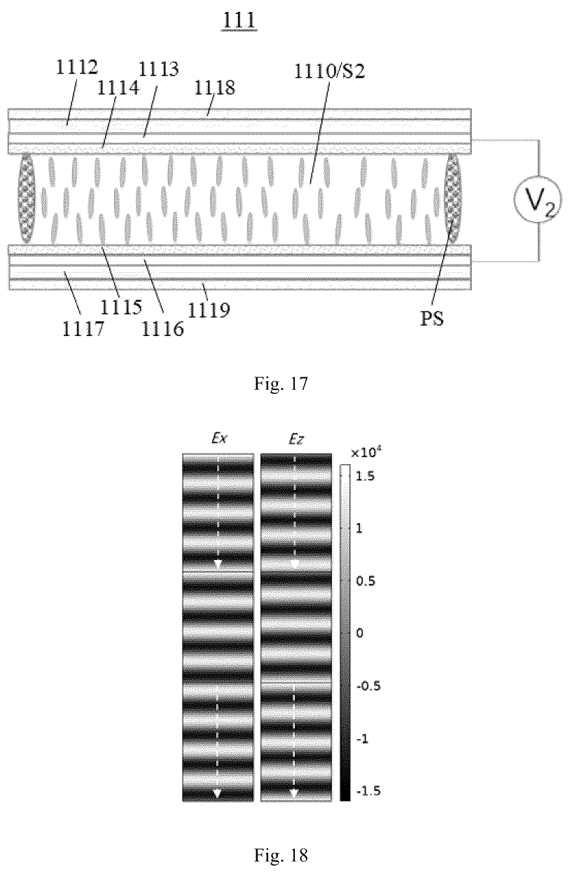

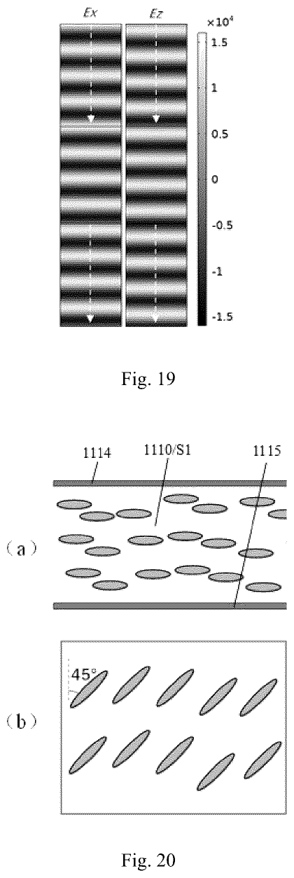

FIG. 17 is a schematic diagram of a liquid crystal variable wave plate under an application of a second voltage according to an embodiment of the present disclosure. FIGS. 18 and 19 are light beam simulation diagrams in a state illustrated by FIG. 17. As illustrated by FIG. 17, in the case that the second voltage V2 applied between the first transparent conductive layer 1113 and the second transparent conductive layer 1116 of the nematic liquid crystal variable wave plate is a saturated voltage, the liquid crystal molecules of the first liquid crystal layer 1110 are rearranged under the action of the electric field, and a long axis of the liquid crystal turns to a direction of the electric field, and the first liquid crystal layer 1110 is in the second state S2. In this case, the nematic liquid crystal variable wave plate 111 is a full wave plate, and the deflection state of light is not changed.

For example, as illustrated by FIG. 18, in the case that the incident light incident on the nematic liquid crystal variable wave plate is left-handed circularly polarized light, the light exited from the nematic liquid crystal variable wave plate is still left-handed circularly polarized light. As illustrated by FIG. 19, in the case that the incident light incident on the nematic liquid crystal variable wave plate is right-handed circularly polarized light, the light exited from the nematic liquid crystal variable wave plate is still right-handed circularly polarized light.

FIG. 20 is a state diagram of a first liquid crystal layer of another liquid crystal variable wave plate after being applied with a first voltage according to an embodiment of the present disclosure; FIG. 21 is a state diagram of the first liquid crystal layer after a second voltage is applied to the liquid crystal variable wave plate illustrated by FIG. 20. As illustrated by FIGS. 20 and 21, in the case that the first liquid crystal layer 1110 adopts ferroelectric liquid crystal, the liquid crystal variable wave plate 111 is called ferroelectric liquid crystal variable wave plate. In the case that no voltage is applied, the ferroelectric liquid crystal molecules are in a spiral state, in the case that the voltage is applied, the ferroelectric liquid crystal molecules are unwound and become the nematic liquid crystal molecules. In the case that negative voltage and positive voltage are applied to the ferroelectric liquid crystal molecules respectively, the long axis of the liquid crystal deflects in different directions respectively, and the deflection angles are about 45 degrees. The ferroelectric liquid crystal is characterized by electrically induced unwinding and has the advantage of fast response.

For example, as illustrated by FIG. 19, (a) in FIG. 19 is a schematic side view of a first liquid crystal layer 1110, and (b) in FIG. 19 is a schematic top view of a first liquid crystal side. In the case that the first voltage V1 applied to the ferroelectric liquid crystal variable wave plate is a positive voltage, the liquid crystal of the first liquid crystal layer 1110 is unwound in a direction under the action of an electric field, and the first liquid crystal layer 1110 is in the first state S1, in this case, the ferroelectric liquid crystal variable wave plate is a half wave plate. For example, in the case that the incident light incident on the ferroelectric liquid crystal variable wave plate is left-handed circularly polarized light, the outgoing light is right-handed circularly polarized light; in the case that the incident light incident on the ferroelectric liquid crystal variable wave plate is right-handed circularly polarized light, the outgoing light is left-handed circularly polarized light.

For example, as illustrated by FIG. 21, (a) in FIG. 21 is a schematic side view of a first liquid crystal layer 1110, and (b) in FIG. 21 is a schematic top view of a first liquid crystal side. In the case that the second voltage V2 applied between the first transparent conductive layer 1113 and the second transparent conductive layer 1116 of the ferroelectric liquid crystal variable wave plate 111 is negative voltage, the liquid crystal of the first liquid crystal layer 1110 is unwound in another direction under the action of an electric field, the first liquid crystal layer 1110 is in the second state S2, in this case, the ferroelectric liquid crystal variable wave plate is a full wave plate, and the deflection state of light is not changed. For example, in the case that the incident light incident on the ferroelectric liquid crystal variable wave plate is left-handed circularly polarized light, the outgoing light is still left-handed circularly polarized light; in the case that the incident light incident on the ferroelectric liquid crystal variable wave plate is right-handed circularly polarized light, the outgoing light is still right-handed circularly polarized light.

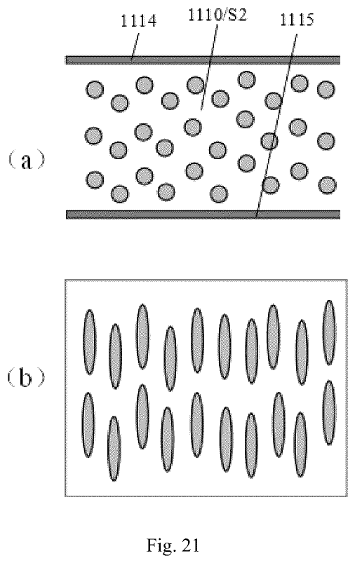

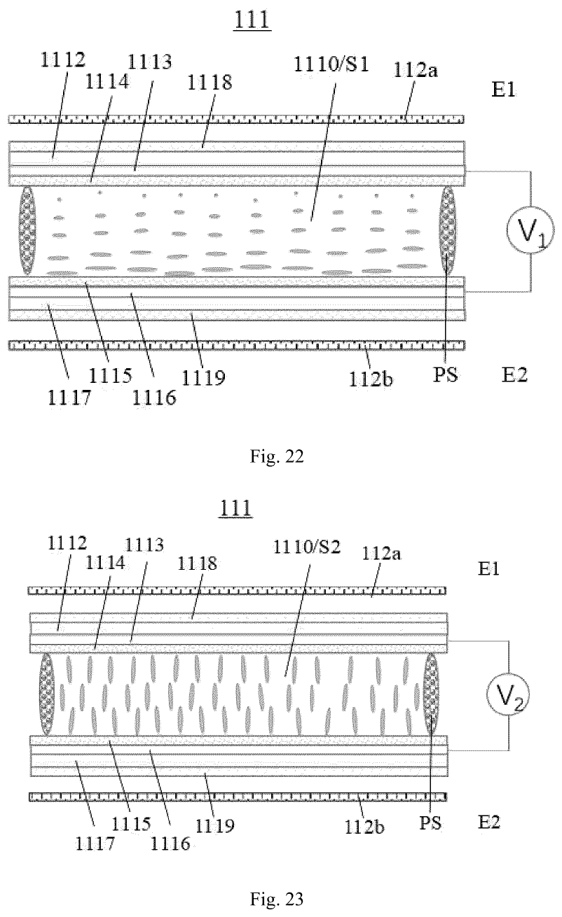

FIG. 22 is a schematic diagram of another liquid crystal variable wave plate under an application of a first voltage according to an embodiment of the present disclosure; FIG. 23 is a schematic diagram of a liquid crystal variable wave plate illustrated by FIG. 22 under an application of a second voltage. As illustrated by FIGS. 22 and 23, the liquid crystal variable wave plate 111 includes a first substrate 1112, a second substrate 1117, a first alignment layer 1114, a second alignment layer 1115, a first transparent conductive layer 1113, a second transparent conductive layer 1116, a first liquid crystal layer 1110, a first quarter-wave plate 112a and a second quarter-wave plate 112b. The second substrate 1117 is arranged opposite to the first substrate 1112, and the first liquid crystal layer 1110 is located between the first substrate 1112 and the second substrate 1117. The first alignment layer 1114 is located between the first liquid crystal layer 1110 and the first substrate 1112, and the second alignment layer 1115 is located between the first liquid crystal layer 1110 and the second substrate 1117, the first transparent conductive layer 1113 is located between the first alignment layer 1114 and the first substrate 1112, and the second transparent conductive layer 1116 is located between the second alignment layer 1115 and the second substrate 1117, the first quarter-wave plate 112a is located at a side of the first substrate 1112 close to the first side E1, and the second quarter-wave plate 112b is located at a side of the second substrate 1117 away from the first side E1.

The first driver includes the first transparent conductive layer 1113 and the second transparent conductive layer 1116, in the case that a voltage signal between the first transparent conductive layer 1113 and the second transparent conductive layer 1116 is a first voltage V1, the first liquid crystal layer 1110 is in the first state S1, in the case that the voltage signal between the first transparent conductive layer 1113 and the second transparent conductive layer 1116 is a second voltage V2, the first liquid crystal layer 1110 is in the second state S2. Therefore, changes between the first state S1 and the second state S2 of the first liquid crystal layer 1110 can be achieved by applying the voltage signals, and the liquid crystal variable wave plate 111 can be switched between the full wave plate and the half wave plate, so that the polarization state of the light beam can be changed or maintained.

For example, in the case that the first liquid crystal layer 1110 adopts twisted nematic (TN) liquid crystal, the liquid crystal variable wave plate 111 is called twisted nematic liquid crystal variable wave plate 111.

For example, as illustrated by FIG. 22, in the case that the first voltage V1 applied between the first transparent conductive layer 1113 and the second transparent conductive layer 1116 of the twisted nematic liquid crystal variable wave plate is 0 V, the liquid crystal of the first liquid crystal layer 1110 is not deflected, and the first liquid crystal layer 1110 is in the first state S1, and a polarization direction of a linearly polarized light is deflected by 90 degrees after the linearly polarized light passing through the twisted nematic liquid crystal. For example, a left-handed circularly polarized light passes through the first quarter-wave plate 112a and becomes a linearly polarized light with the polarization direction of EH, the polarization direction of the linearly polarized light is deflected by 90 degrees and becomes the polarization direction of EV after the linearly polarized light EH passing through the twisted nematic liquid crystal, and the linearly polarized light EV passes through the second quarter-wave plate 112b and becomes a right-handed circularly polarized light, therefore, the left-handed circularly polarized light passes through the twisted nematic liquid crystal variable wave plate 111 and becomes the right-handed circularly polarized light, or vice versa, which will not be described again here.

For example, as illustrated by FIG. 23, in the case that the first voltage V1 applied between the first transparent conductive layer 1113 and the second transparent conductive layer 1116 of the twisted nematic liquid crystal variable wave plate is a saturated voltage, the liquid crystals in the first liquid crystal layer 1110 are rearranged under the action of an electric field, and the long axis of the liquid crystal turns to the direction of the electric field, so that the first liquid crystal layer 1110 is in the second state S2, and the polarization direction of the linearly polarized light remains unchanged after the linearly polarized light passing through the twisted nematic liquid crystal. For example, the left-handed circularly polarized light passes through the first quarter-wave plate 112a and becomes the linearly polarized light with the polarization direction of EH, the polarization direction is not changed after the linearly polarized light EH passing through the twisted nematic liquid crystal, and the linearly polarized light EH passes through the second quarter-wave plate 112b and becomes the left-handed circularly polarized light, therefore, the left-handed circularly polarized light passes through the twisted nematic liquid crystal variable wave plate 111 and is still left-handed circularly polarized light, or vice versa, which will not be described again here.

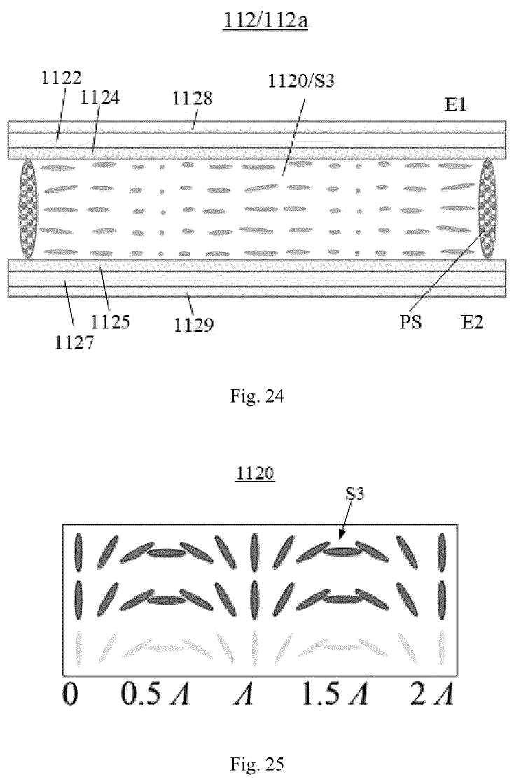

FIG. 24 is a schematic side view of a liquid crystal polarization grating according to an embodiment of the present disclosure; FIG. 25 is a schematic top view of a second liquid crystal layer of a liquid crystal polarization grating illustrated by FIG. 24. As illustrated by FIGS. 24 and 25, the liquid crystal polarization grating 112 includes a third substrate 1122, a fourth substrate 1127, a third alignment layer 1124, a fourth alignment layer 1125 and a second liquid crystal layer 1120. The fourth substrate 1127 is opposite to the third substrate 1122. The second liquid crystal layer 1120 is located between the third substrate 1122 and the fourth substrate 1127, the third alignment layer 1124 is located between the second liquid crystal layer 1120 and the third substrate 1122, and the fourth alignment layer 1125 is located between the second liquid crystal layer 1120 and the fourth substrate 1127. The liquid crystal polarization grating 112 may also be called a passive liquid crystal polarization grating 112a. Through the passive liquid crystal polarization grating 112a, the polarization state and deflection angle of the incident light can be changed.

In some examples, the passive liquid crystal polarization grating 112a may use liquid crystal polymer and adopt spin coating process, multi-layer spin coating to control a thickness of a liquid crystal cell, and the liquid crystal polymer is finally cured by ultraviolet radiation.

In some examples, liquid crystal directors of the second liquid crystal layer 1120 of the passive liquid crystal polarization grating 112a show periodic variation, and the thickness of the second liquid crystal layer 1120 may be in a range from 2 μm to 5 μm.

In some examples, the third substrate 1122 may be an encapsulation layer, such as silicon dioxide, carbon tetrachloride, polymethylmethacrylate (PMMA) or the like. For example, the fourth substrate 1127 may be high-transparent glass. For example, the thickness of the third substrate 1122 may be in a range from 100 μm to 700 μm.

In some examples, because the orientation of liquid crystal of the passive liquid crystal polarization grating 112a show periodic deflection, the third alignment layer 1124 and the fourth alignment layer 1125 are usually aligned by the photo-controlled alignment process, and the materials used for the photo-controlled alignment process include azobenzene (SD1), polyethylene 4-methoxycinnamate (PVMC), photosensitive polyimide, etc. For example, the thicknesses of the third alignment layer 1124 and the fourth alignment layer 1125 may each be in a range from 100 nm to 500 nm.

In some examples, as illustrated by FIG. 24, the passive liquid crystal polarization grating 112a may further include a third antireflection film 1128 and a fourth antireflection film 1129, the third antireflection film 1128 is located at a side of the third substrate 1122 away from the second liquid crystal layer 1120, and the fourth antireflection film 1129 is located at a side of the fourth substrate 1127 away from the second liquid crystal layer 1120. The third antireflection film 1128 and the fourth antireflection film 1129 can decrease the reflection of the light beam and increase the transmission of the light beam, so that the transmittance of light incident on the liquid crystal variable wave plate 111 can be increased. For example, thicknesses of the third antireflection film 1128 and the fourth antireflection film 1129 may each be in a range from 200 nm to 1 μm.

In some examples, as illustrated by FIG. 24, the passive liquid crystal polarization grating 112a may further include a plurality of isolation columns PS located between the third substrate 1122 and the fourth substrate 1127 to support the third substrate 1122 and the fourth substrate 1127 and seal the second liquid crystal layer 1120.

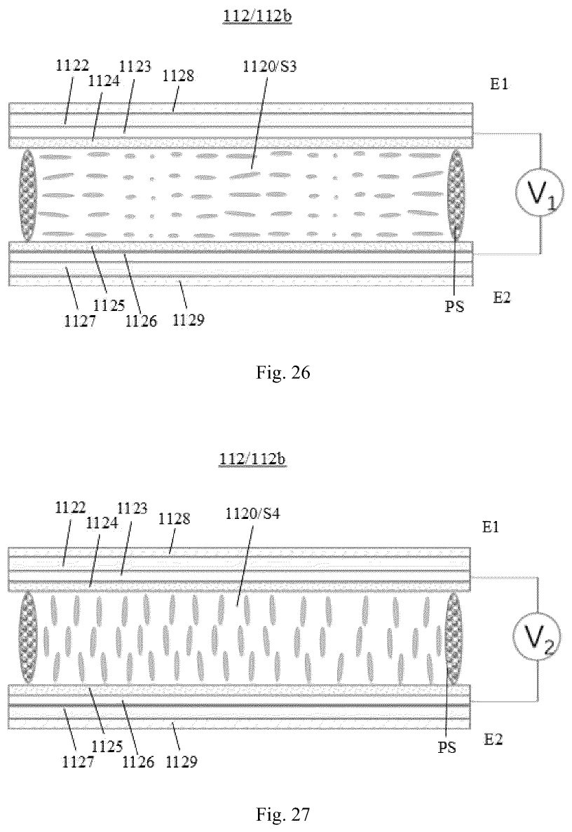

FIG. 26 is a schematic diagram of another liquid crystal polarization grating applied with a third voltage according to an embodiment of the present disclosure; FIG. 27 is a schematic diagram of a liquid crystal polarization grating illustrated by FIG. 26 applied with a fourth voltage. As illustrated by FIGS. 26 and 27, the liquid crystal polarization grating 112 includes a third substrate 1122, a fourth substrate 1127, a third alignment layer 1124, a fourth alignment layer 1125, a third transparent conductive layer 1123, a fourth transparent conductive layer 1126 and a second liquid crystal layer 1120. The fourth substrate 1127 is arranged opposite to the third substrate 1122, and the second liquid crystal layer 1120 is located between the third substrate 1122 and the fourth substrate 1127. The third alignment layer 1124 is located between the second liquid crystal layer 1120 and the third substrate 1122, the fourth alignment layer 1125 is located between the second liquid crystal layer 1120 and the fourth substrate 1127, the third transparent conductive layer 1123 is located between the third alignment layer 1124 and the third substrate 1122, and the fourth transparent conductive layer 1126 is located between the fourth alignment layer 1125 and the fourth substrate 1127. The second driver includes the third transparent conductive layer 1123 and the fourth transparent conductive layer 1126.

As illustrated by FIG. 26, in the case that the voltage signal between the third transparent conductive layer 1123 and the fourth transparent conductive layer 1126 is the third voltage V3, the second liquid crystal layer 1120 is in the third state S3, which is the same as the third state S3 illustrated by FIGS. 24 and 26. As illustrated by FIG. 27, in the case that the voltage signal between the third transparent conductive layer 1123 and the fourth transparent conductive layer 1126 is the fourth voltage V4, the second liquid crystal layer 1120 is in the fourth state S4. The liquid crystal polarization grating 112 may also be called the active liquid crystal polarization grating 112b. The changes between the third state S3 and the fourth state S4 of the second liquid crystal layer 1120 can be achieved by applying different voltage signals, so that the polarization state and the deflection angle of the incident light can be changed or not.

For example, as illustrated by FIG. 26, in the case that the third voltage V3 applied between the third transparent conductive layer 1123 and the fourth transparent conductive layer 1126 of the active liquid crystal polarization grating 112b is 0 V, the liquid crystal of the second liquid crystal layer 1120 is not deflected, the liquid crystal directors of the second liquid crystal layer show periodic variation, and the second liquid crystal layer 1120 is in the third state S3, in this case, the active liquid crystal polarization grating 112b deflects the incident light, the set angle θ of deflection is related to a period A of the liquid crystal polarization grating 112 (as illustrated by FIG. 25). The smaller the grating period A is, the larger the set angle θ of deflection is, and the set angle θ of deflection and the period A of the liquid crystal polarization grating 112 satisfy the formula:

$$θ = \pm arcsin \frac{λ}{Λ} ,$$

For example, as illustrated by FIG. 27, in the case that the fourth voltage V4 applied between the third transparent conductive layer 1123 and the fourth transparent conductive layer 1126 of the active liquid crystal polarization grating 112b is a saturated voltage, the liquid crystal molecules of the second liquid crystal layer 1120 are rearranged under the action of the electric field, and the long axis of the liquid crystal turns to the direction of the electric field, and the second liquid crystal layer 1120 is in the fourth state S4, in this case, the active liquid crystal polarization grating 112b has no deflection effect on the incident light.

In some examples, in the third state S3, the liquid crystal directors of the second liquid crystal layer 1120 show periodic variation, and the thickness of the second liquid crystal layer 1120 may be in a range from 2 μm to 5 μm.

In some examples, the third alignment layer 1124 and the fourth alignment layer 1125 may be formed by a rubbing alignment process or a photo-controlled alignment process. For example, thicknesses of the third alignment layer 1124 and the fourth alignment layer 1125 may each be in a range from 100 μm to 500 μm.

In some examples, thicknesses of the third transparent conductive layer 1123 and the fourth transparent conductive layer 1126 may be in a range from 500 nm to 2 μm. For example, materials of the third transparent conductive layer 1123 and the fourth transparent conductive layer 1126 may be indium tin oxide (ITO) or the like.

In some examples, the third substrate 1122 and the fourth substrate 1127 may be high-transparent glass. For example, thicknesses of the third substrate 1122 and the fourth substrate 1127 may each be in a range from 100 μm to 700 μm.

In some examples, as illustrated by FIGS. 26 and 27, the active liquid crystal polarization grating 112b may further include a third antireflection film 1128 and a fourth antireflection film 1129, the third antireflection film 1128 is located on a side of the third substrate 1122 away from the second liquid crystal layer 1120, and the fourth antireflection film 1129 is located on a side of the fourth substrate 1127 away from the second liquid crystal layer 1120, the third antireflection film 1128 and the fourth antireflection film 1129 can decrease the reflection of the light beam and increase the transmission of the light beam, so that the transmittance of light incident on the liquid crystal variable wave plate 111 can be increased. For example, thicknesses of the third antireflection film 1128 and the fourth antireflection film 1129 may each be in a range from 200 nm to 1 μm.

In some examples, as illustrated by FIGS. 26 and 27, the active liquid crystal polarization grating 112b may further include a plurality of isolation columns PS located between the third substrate 1122 and the fourth substrate 1127 to support the third substrate 1122 and the fourth substrate 1127 and seal the second liquid crystal layer 1120.

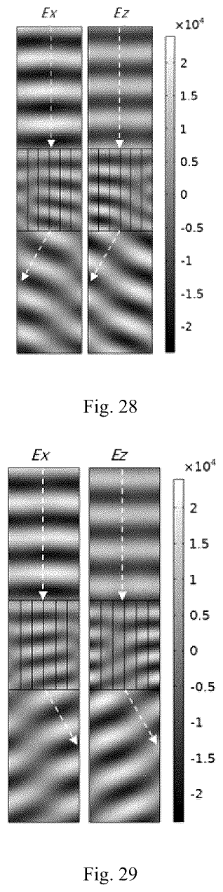

FIGS. 28 to 35 are light beam simulation diagrams of different grating periods in a state illustrated by FIG. 26. As illustrated by FIGS. 28 to 35, taking the incident light of 940 nm as an example, in the case that no voltage is applied to two sides of the active liquid crystal polarization grating 112b, that is to say, in the case that the third voltage V3 is 0 V, the left-handed circularly polarized light is vertically incident from above, and the right-handed circularly polarized light is obliquely exited from the lower left; the right-handed circularly polarized light is vertically incident from above, and the left-handed circularly polarized light is obliquely exited from the lower right.

For example, in the case that the grating period is 1.9 μm, according to the above formula, the set angle θ of deflection of the liquid crystal polarization grating 112 is 30 degrees, as illustrated by FIG. 28, the left-handed circularly polarized light is vertically incident from above, and the right-handed circularly polarized light is obliquely exited from the lower left, as illustrated by FIG. 29, the right-handed circularly polarized light is vertically incident from above, and the left-handed circularly polarized light is obliquely exited from the lower right.

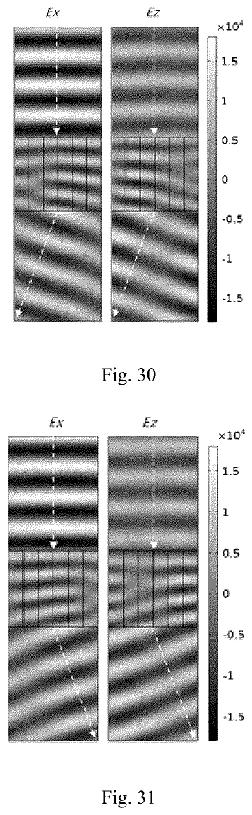

For example, in the case that the grating period is 2.8 μm, the set angle θ of deflection of the liquid crystal polarization grating 112 is 20 degrees, as illustrated by FIG. 30, the left-handed circularly polarized light is vertically incident from above, and the right-handed circularly polarized light is obliquely exited from the lower left, as illustrated by FIG. 31, the right-handed circularly polarized light is vertically incident from above, and the left-handed circularly polarized light is obliquely exited from the lower right.

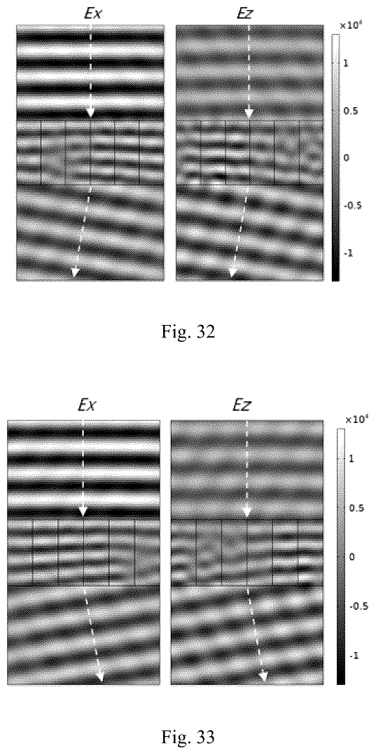

For example, in the case that the grating period is 5.4 μm, the set angle θ of deflection of the liquid crystal polarization grating 112 is 10 degrees, as illustrated by FIG. 32, the left-handed circularly polarized light is vertically incident from above, and the right-handed circularly polarized light is obliquely exited from the lower left, as illustrated by FIG. 33, the right-handed circularly polarized light is vertically incident from above, and the left-handed circularly polarized light is obliquely exited from the lower right.

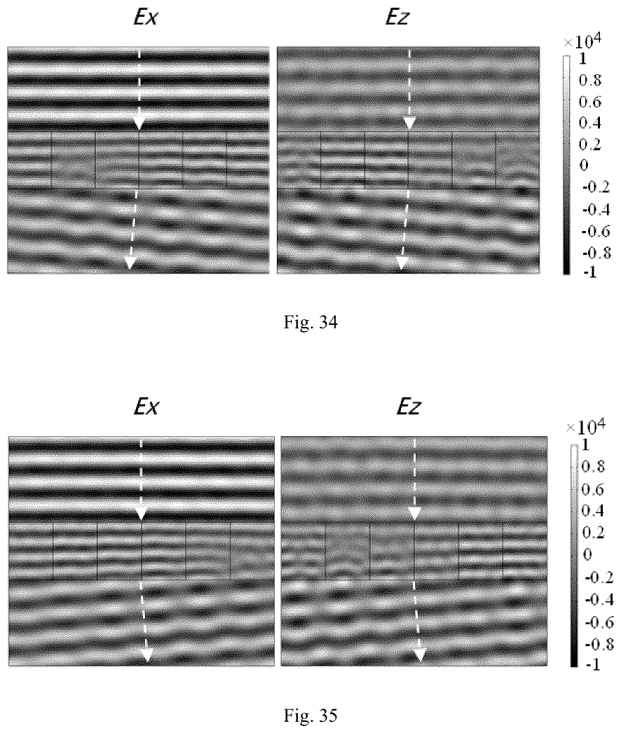

For example, in the case that the grating period is 10.8 μm, the set angle θ of deflection of the liquid crystal polarization grating 112 is 5 degrees, as illustrated by FIG. 34, the left-handed circularly polarized light is vertically incident from above, and the right-handed circularly polarized light is obliquely exited from the lower left, as illustrated by FIG. 35, the right-handed circularly polarized light is vertically incident from above, and the left-handed circularly polarized light is obliquely exited from the lower right.

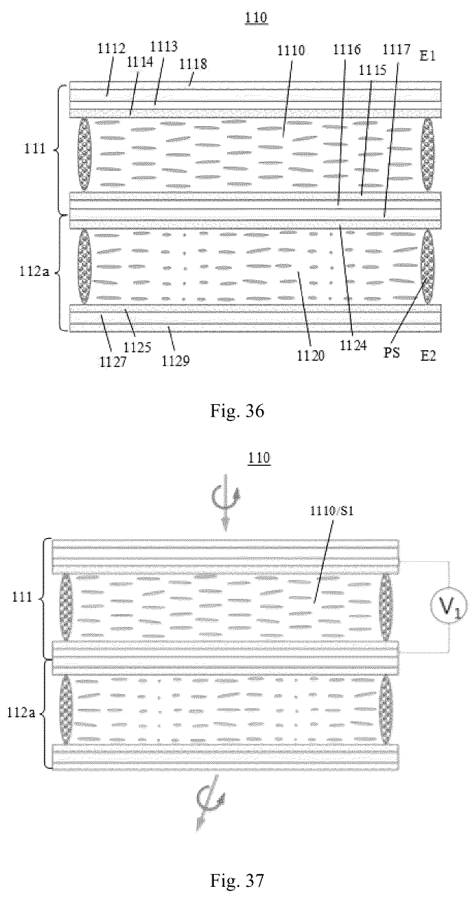

FIG. 36 is a structural schematic diagram of a light beam deflection structure provided by an embodiment of the present disclosure. As illustrated by FIG. 36, the light beam deflection structure 110 includes the passive liquid crystal polarization grating 112a and the liquid crystal variable wave plate 111, the liquid crystal variable wave plate 111 may be selected from the nematic liquid crystal variable wave plate, the ferroelectric liquid crystal variable wave plate or the twisted nematic liquid crystal variable wave plate.

As illustrated by FIG. 36, the liquid crystal variable wave plate 111 of the light beam deflection structure 110 includes the first substrate 1112, the second substrate 1117, the first alignment layer 1114, the second alignment layer 1115, the first transparent conductive layer 1113, the second transparent conductive layer 1116 and the first liquid crystal layer 1110. The passive liquid crystal polarization grating 112a of the light beam deflection structure 110 includes the second substrate 1117 shared with the liquid crystal variable wave plate 111, the fourth substrate 1127, the third alignment layer 1124, the fourth alignment layer 1125 and the second liquid crystal layer 1120. For example, the first substrate 1112, the second substrate 1117 and the fourth substrate 1127 may be high-transparent glasses.

In some examples, as illustrated by FIG. 36, the light beam deflection structure 110 may further include the first antireflection film 1118 close to the first side E1 and the fourth antireflection film 1129 close to the second side E2, and a plurality of isolation columns PS arranged between the first substrate 1112 and the second substrate 1117, and between the second substrate 1117 and the fourth substrate 1127.

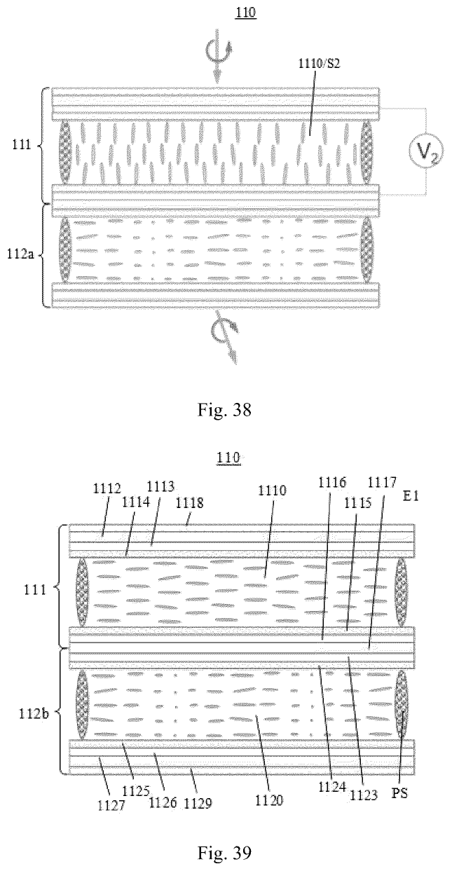

FIGS. 37 and 38 are schematic diagrams of light beam deflection of the light beam deflection structure illustrated by FIG. 36. As illustrated by FIG. 37, in the case that the first voltage V1 is applied to the liquid crystal variable wave plate 111, for example, the voltage state is recorded as “0” and the first liquid crystal layer 1110 is in the first state S1, the liquid crystal variable wave plate 111 converts the right-handed circular polarization of the incident light into the left-handed circular polarization, the left-handed circularly polarized light passes through the passive liquid crystal polarization grating 112a and becomes the right-handed circularly polarized light, and the light beam is deflected to the lower left by the set angle θ, a magnitude of the set angle θ depends on the period A of the liquid crystal polarization grating 112.

As illustrated by FIG. 38, in the case that the second voltage V2 is applied to the liquid crystal variable wave plate 111, for example, the voltage state is recorded as “1”, and the first liquid crystal layer 1110 is in the second state S2, the liquid crystal variable wave plate 111 does not change the polarization state of the incident light, the right-handed circularly polarized light passes through the passive liquid crystal polarization grating 112a and is deflected to the lower right by the set angle θ, the magnitude of the set angle θ depends on the period A of the liquid crystal polarization grating 112.

FIG. 39 is a structural schematic diagram of another light beam deflection structure provided by an embodiment of the present disclosure. As illustrated by FIG. 39, the light beam deflection structure 110 includes the active liquid crystal polarization grating 112b and the liquid crystal variable wave plate 111, the liquid crystal variable wave plate 111 may be selected from the nematic liquid crystal variable wave plate, the ferroelectric liquid crystal variable wave plate and the twisted nematic liquid crystal variable wave plate.

As illustrated by FIG. 39, the liquid crystal variable wave plate 111 of the light beam deflection structure 110 includes the first substrate 1112, the second substrate 1117, the first alignment layer 1114, the second alignment layer 1115, the first transparent conductive layer 1113, the second transparent conductive layer 1116 and the first liquid crystal layer 1110. The active liquid crystal polarization grating 112b of the light beam deflection structure 110 includes the second substrate 1117 shared with the liquid crystal variable wave plate 111, the fourth substrate 1127, the third alignment layer 1124, the fourth alignment layer 1125, the third transparent conductive layer 1123, the fourth transparent conductive layer 1126 and the second liquid crystal layer 1120. For example, the first substrate 1112, the second substrate 1117 and the fourth substrate 1127 may be high-transparent glasses.

In some examples, as illustrated by FIG. 39, the light beam deflection structure 110 may further include the first antireflection film 1118 close to the first side E1 and the fourth antireflection film 1129 close to the second side E2, and a plurality of isolation columns PS arranged between the first substrate 1112 and the second substrate 1117, and between the second substrate 1117 and the fourth substrate 1127.

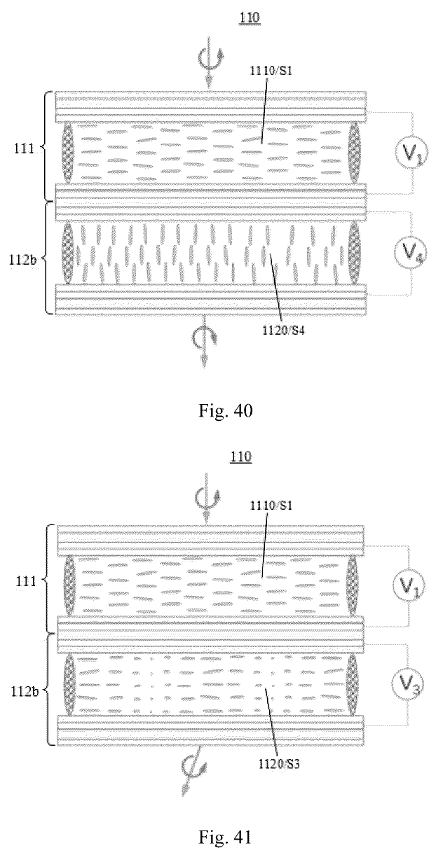

FIGS. 40 to 42 are schematic diagrams of light beam deflection of the light beam deflection structure illustrated by FIG. 39. As illustrated by FIG. 40, in the case that the first voltage V1 is applied to the liquid crystal variable wave plate 111, for example, the voltage state is recorded as “0”, and the first liquid crystal layer 1110 is in the first state S1, the liquid crystal variable wave plate 111 converts the right-handed circular polarization of the incident light into the left-handed circular polarization, the fourth voltage V4 is applied to the active liquid crystal polarization grating 112b, for example, the voltage state is recorded as “1”, and the second liquid crystal layer 1120 is in the fourth state S4, the left-handed circularly polarized light is not changed after passing through the active liquid crystal polarization grating 112b, and the light beam is not deflected.

As illustrated by FIG. 41, in the case that the first voltage V1 is applied to the liquid crystal variable wave plate 111, for example, the voltage state is recorded as “0”, and the first liquid crystal layer 1110 is in the first state S1, the liquid crystal variable wave plate 111 converts the right-handed circular polarization of the incident light into the left-handed circular polarization, the third voltage V3 is applied to the active liquid crystal polarization grating 112b, for example, the voltage state is recorded as “0”, and the second liquid crystal layer 1120 is in the third state S3, the left-handed circularly polarized light passes through the active liquid crystal polarization grating 112b and becomes the right-handed circularly polarized light, and the light beam is deflected to the lower left by the set angle θ, the magnitude of the set angle θ depends on the period A of the liquid crystal polarization grating 112.

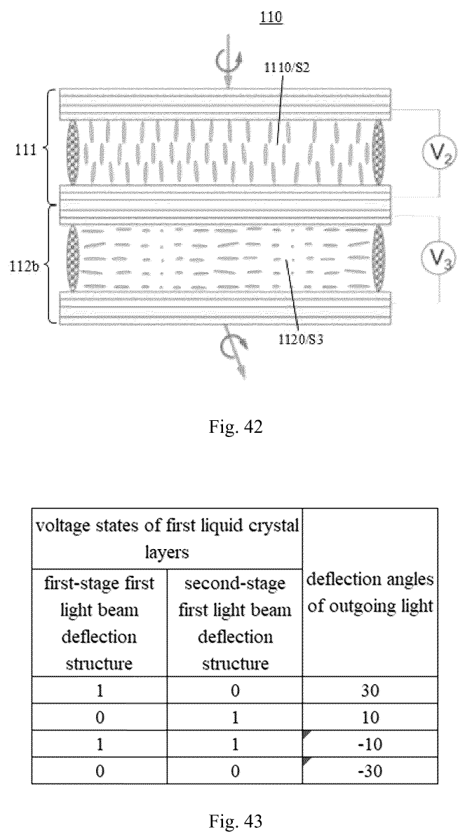

As illustrated by FIG. 42, in the case that the second voltage V2 is applied to the liquid crystal variable wave plate 111, for example, the voltage state is recorded as “1”, and the first liquid crystal layer 1110 is in the second state S2, the liquid crystal variable wave plate 111 does not change the polarization state of the incident light; the third voltage V3 is applied to the active liquid crystal polarization grating 112b, for example, the voltage state is recorded as “0”, and the second liquid crystal layer 1120 is in the third state S3, the right-handed circularly polarized light passes through the active liquid crystal polarization grating 112b and becomes the left-handed circularly polarized light, and the light beam is deflected to the lower right by the set angle θ, the magnitude of the set angle θ depends on the period A of the liquid crystal polarization grating 112.

FIG. 43 is a diagram illustrating corresponding relationship of voltage states of first liquid crystal layers and deflection angles of outgoing light of a light beam deflection device illustrated by FIG. 4. As illustrated by FIGS. 4 and 43, the light beam deflection device 100 includes two light beam deflection structures 110, which are arranged along the direction that the first side E1 points to the second side E2. The liquid crystal polarization gratings 112 of the two light beam deflection structures 110 may both be the passive liquid crystal polarization gratings 112a. For example, the set angle θ of deflection of the passive liquid crystal polarization grating 112a of the light beam deflection structure 110 close to the first side E1 is 10 degrees, and the set angle θ of deflection of the passive liquid crystal polarization grating 112a of the light beam deflection structure 110 close to the second side E2 is 20 degrees. Taking the liquid crystal variable wave plate 111 being the nematic liquid crystal variable wave plate 111 as an example, the deflection angles illustrated by FIG. 43 can be obtained by applying the voltages illustrated by FIG. 43 to the two liquid crystal variable wave plates 111 of the light beam deflection device 100. Therefore, the light beam deflection device 100 can realize the deflection of the light beam in a range between-30 degrees and 30 degrees. In the figure, the number “1” represents the saturation voltage, that is, the second voltage V2 mentioned above, and the number “0” represents the turn-off voltage, that is, the first voltage V1 mentioned above.

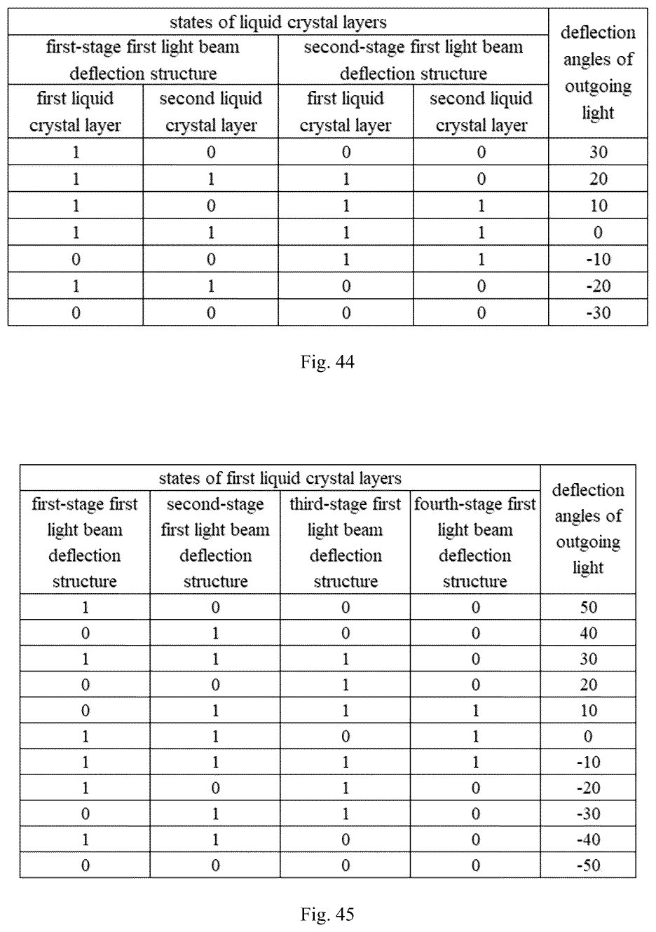

FIG. 44 is a diagram illustrating corresponding relationship of voltage states of liquid crystal layers of a light beam deflection device and deflection angles of outgoing light illustrated by FIG. 4. As illustrated by FIGS. 4 and 44, the light beam deflection device 100 includes two light beam deflection structures 110, which are arranged along the direction that the first side E1 points to the second side E2. The liquid crystal polarization gratings 112 of the two light beam deflection structures 110 may both be the active liquid crystal polarization gratings 112b. For example, the set angle θ of deflection of the active liquid crystal polarization grating 112b of the light beam deflection structure 110 close to the first side E1 is 10 degrees, and the set angle θ of deflection of the active liquid crystal polarization grating 112b of the light beam deflection structure 110 close to the second side E2 is 20 degrees. Taking the liquid crystal variable wave plate 111 being the nematic liquid crystal variable wave plate 111 as an example, the light beam deflection device 100 can obtain the deflection angles illustrated by FIG. 44 by applying the voltages illustrated by FIG. 44 to the two liquid crystal variable wave plates 111 and the two active liquid crystal polarization gratings 112b of the light beam deflection device 100. Therefore, the light beam deflection device 100 can realize the deflection of the light beam in a range between −30 degrees and 30 degrees.

FIG. 45 is a diagram illustrating corresponding relationship of voltage states of a first liquid crystal layer and deflection angles of outgoing light of a light beam deflection device illustrated by FIG. 6. As illustrated by FIGS. 6 and 45, the light beam deflection device 100 includes four light beam deflection structures 110, which are arranged along the direction that the first side E1 points to the second side E2. The liquid crystal polarization gratings 112 of the four light beam deflection structures 110 may both be the passive liquid crystal polarization gratings 112a. For example, the set angles θ of deflection of the four passive liquid crystal polarization gratings 112a arranged along the direction from the first side E1 to the second side E2 are 5 degrees, 10 degrees, 15 degrees and 20 degrees, respectively. Taking the liquid crystal variable wave plate 111 being the nematic liquid crystal variable wave plate 111 as an example, the light beam deflection device 100 can obtain the deflection angles illustrated by FIG. 45 by applying the voltages illustrated by FIG. 45 to the four liquid crystal variable wave plates 111 of the light beam deflection device 100. Therefore, the light beam deflection device 100 can realize the deflection of the light beam in a range between −50 degrees and 50 degrees.

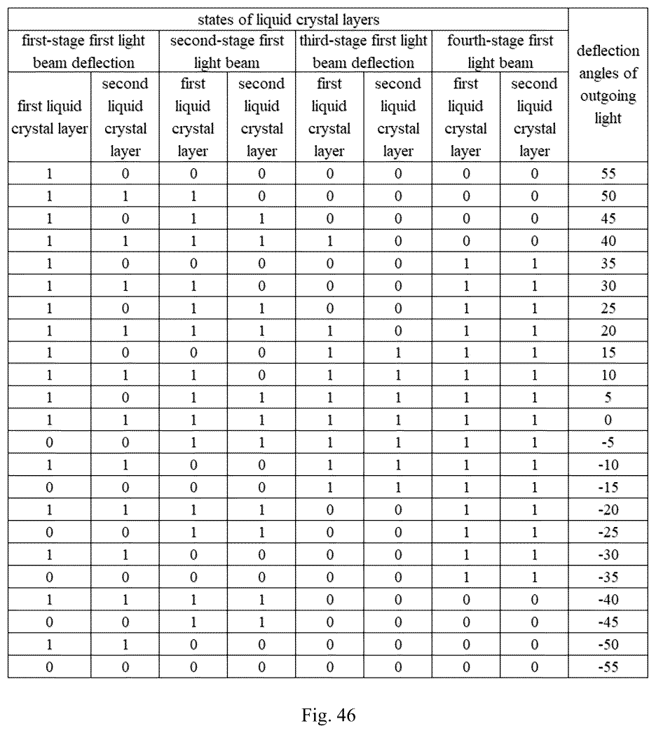

FIG. 46 is a diagram illustrating corresponding relationship of voltage states of liquid crystal layers and deflection angles of outgoing light of a light beam deflection device illustrated by FIG. 6. As illustrated by FIGS. 6 and 46, the light beam deflection device 100 includes four light beam deflection structures 110, which are arranged along the direction that the first side E1 points to the second side E2. The liquid crystal polarization gratings 112 of the four light beam deflection structures 110 may all be the active liquid crystal polarization gratings 112b. For example, the set angles θ of deflection of the four active liquid crystal polarization gratings 112b arranged along the direction from the first side E1 to the second side E2 are 5 degrees, 10 degrees, 20 degrees and 20 degrees, respectively. Taking the liquid crystal variable wave plate 111 being the nematic liquid crystal variable wave plate 111 as an example, the deflection angles illustrated by FIG. 46 can be obtained by applying the voltages illustrated by FIG. 46 to the four liquid crystal variable wave plates 111 and the four active liquid crystal polarization gratings 112b of the light beam deflection device 100. Therefore, the light beam deflection device 100 can realize the deflection of the light beam between −55 degrees and 55 degrees.

In some examples, the four light beam deflection structures 110 in the light beam deflection device 100 illustrated by FIG. 6 may all be the first light beam deflection structures 1101, and the two light beam deflection structures 110 in the light beam deflection device 100 illustrated by FIG. 4 may all be the second light beam deflection structures 1102. The four first light beam deflection structures 1101 in FIG. 6 and the two second light beam deflection structures 1102 in FIG. 4 are arranged along the direction that the first side E1 points to the second side E2 to form the light beam deflection device, therefore, the light beam deflection device can realize the deflection of the light beam in two planes and realize the two-dimensional scanning of light beam. For example, the light beam deflection device 100 formed by the light beam deflection structures of FIGS. 6 and 4 can realize the deflection between −55 degrees and 55 degrees in the first plane, and meanwhile, can realize the deflection between −30 degrees and 30 degrees in the second plane. Of course, the embodiment of the present disclosure is not limited thereto, and other number and set angles of the light beam deflection structures 110 can be arranged along the direction in which the incident light points to the second side E2, so that other scanning angles can be obtained.

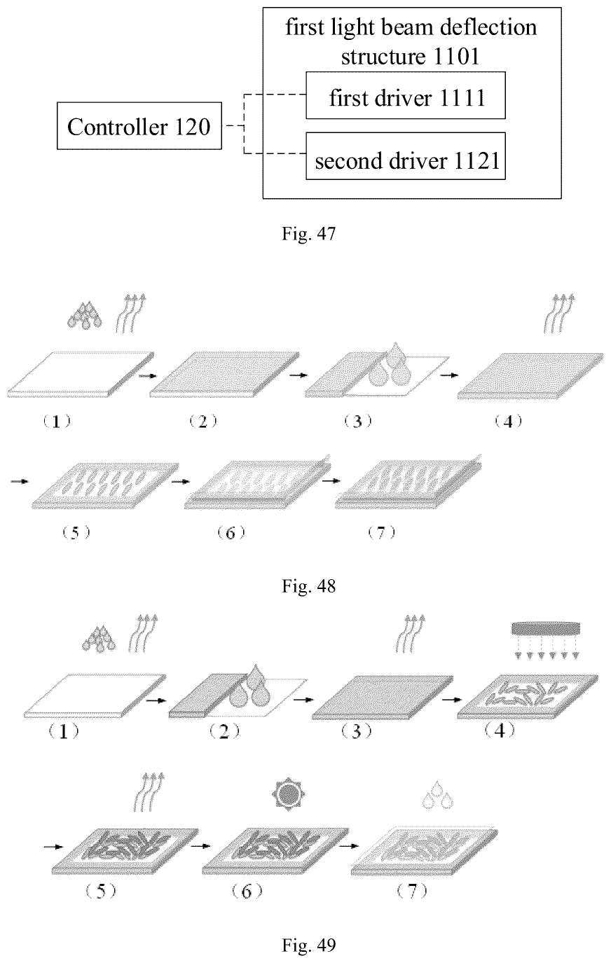

FIG. 47 is a schematic diagram of another light beam deflection device provided by an embodiment of the present disclosure. As illustrated by FIG. 47, the light beam deflection device 100 further includes a controller 120, which is respectively connected to and in communication with a plurality of first drivers 1111 of a plurality of first light beam deflection structures 1101, and is configured to provide voltage signals to the first drivers 1111 to make the first liquid crystal layer 1110 be in the first state S1 or the second state S2. For example, the controller 120 may be communicatively connected with the first transparent conductive layers 1113 and the second transparent conductive layers 1116 of the plurality of first light beam deflection structures 1101 to provide the voltage signals thereto.

In some examples, as illustrated by FIG. 47, the controller 120 of the light beam deflection device 100 may further be respectively connected to and in communication with the plurality of second drivers 1121 of the plurality of first light beam deflection structures 1101, and is configured to provide the voltage signals to the second drivers 1121 to make the second liquid crystal layer 1120 be in the third state S3 or the fourth state S4. For example, the controller 120 may be communicatively connected with the third transparent conductive layer 1123 and the fourth transparent conductive layer 1126 of the plurality of first light beam deflection structures 1101 to provide voltage signals thereto.

In some examples, the controller 120 of the light beam deflection device 100 may further be respectively connected and in communication with the plurality of drivers of the plurality of second light beam deflection structures 1102, which will not be described again here.

It should be noted that, FIG. 47 schematically illustrates one first driver 1111 and one second driver 1121 of one first light beam deflection structure 1101, which is only used to illustrate the communication connection relationship between the controller and the driver, and is not a limitation to the light beam deflection device 100.

FIG. 48 is a process flow chart of preparing a liquid crystal variable wave plate according to an embodiment of the present disclosure. As illustrated by FIG. 48, (1) the glass is cleaned with deionized water and then dried, (2) indium tin oxide (ITO) is deposited by magnetron sputtering to prepare a transparent electrode, (3) a polyimide (PI) layer is spin-coated, (4) a drying treatment is carried out, (5) the polyimide (PI) layer is aligned by flannel rubbing, (6) the structure prepared above is aligned and cell-assembled with a high-transparent glass coated with indium tin oxide (ITO), ensuring that the ITO layers face each other, and the thickness of the liquid crystal cell is determined by using the frame sealing adhesive mixed with polystyrene beads, and (7) finally, after vacuum filling with liquid crystals and encapsulation, the liquid crystal cell fabrication is completed. The liquid crystal cell can be used for the liquid crystal variable wave plate 111 in the present disclosure.

FIG. 49 is a manufacturing process flow chart of a passive liquid crystal polarization grating provided by an embodiment of the present disclosure. As illustrated by FIG. 49, (1) firstly, the glass is cleaned with deionized water and then dried, (2) then the azobenzene photo-alignment material is coated, (3) the drying treatment is carried out, (4) the patterned alignment is realized by polarized light, (5) the liquid crystal and polymer intermediates are coated by spin coating for many times, (6) after reaching the required thickness, the polymer is cured by ultraviolet light, and (7) finally, the encapsulation layer is coated to be water-proof and oxygen-proof, the liquid crystal cell fabrication is completed. The liquid crystal cell can be used for the passive liquid crystal polarization grating 112a in the present disclosure.

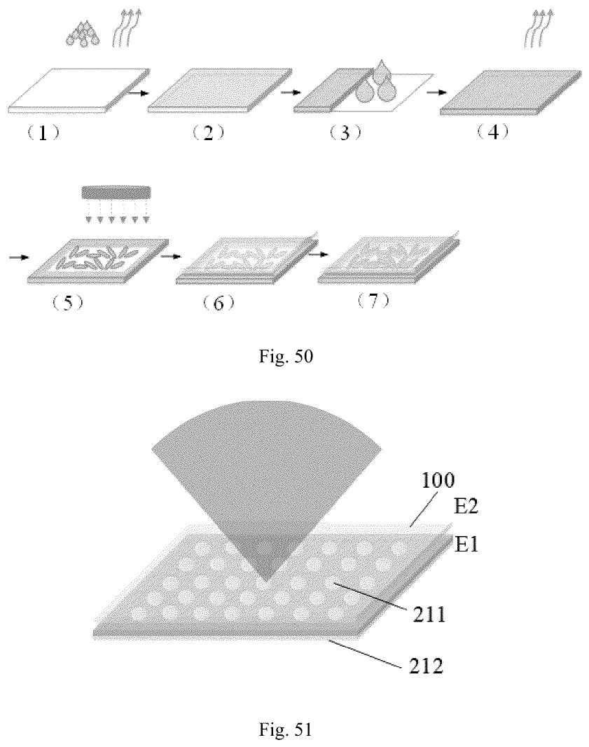

FIG. 50 is a process flow chart of preparing an active liquid crystal polarization grating according to an embodiment of the present disclosure. As illustrated by FIG. 50, the glass is cleaned with deionized water and then dried, and then indium tin oxide (ITO) is deposited by magnetron sputtering to prepare the transparent electrode. Then azobenzene photo-alignment material is coated, dried, and then patterned alignment is achieved through polarized light. The structure prepared above is aligned and cell-assembled with a high-transparent glass coated with indium tin oxide (ITO), ensuring that the ITO layers face each other, and the thickness of the liquid crystal cell is determined by the frame sealing adhesive mixed with polystyrene beads. Finally, vacuum filling with liquid crystals and encapsulation, the liquid crystal cell fabrication is completed. The liquid crystal cell can be used for the active liquid crystal polarization grating 112b in the present disclosure.

The embodiment of the present disclosure further provides a laser radar. FIG. 51 is a schematic structural diagram of a laser emitting system of a laser radar provided by an embodiment of the present disclosure. As illustrated by FIG. 51, the laser radar includes a laser emitting system 210, which includes a plurality of lasers 211 and any one of the above-mentioned light beam deflection devices 100, the plurality of lasers 211 are arranged corresponding to the light beam deflection device 100, and the plurality of lasers 211 are located at the first side E1 of the light beam deflection device 100 and are configured to emit light beam to the light beam deflection device 100. Therefore, the laser radar has the beneficial effects corresponding to those of the light beam deflection device 100. The light beam deflection device 100 can deflect the light beam emitted by the laser 211 to achieve a large field of view angle, and the light beam scanning can be further achieved by changing the state of the liquid crystal layers in the light beam deflection device 100, thereby reducing the number of lasers 211, and the size and cost of the laser emitting system 210 are reduced. A fan-shaped region in the figure represents the light beam emitted from the laser emitting system 210.

For example, in the case that the light beam deflection device 100 includes the plurality of first light beam deflection structures 1101, the laser radar can realize one-dimensional scanning of light beams. For example, in the case that the light beam deflection device 100 includes a plurality of first light beam deflection structures 1101 and at least one second light beam deflection structure 1102, the laser radar can realize two-dimensional scanning.

In some examples, as illustrated by FIG. 51, the laser emitting system 210 further includes a first driving chip 212, which includes a laser driving chip and a light beam deflection device driving chip, the laser driving chip is configured to drive the laser 211 to emit the light beam, and the light beam deflection device driving chip is configured to drive the light beam deflection device to deflect the light beam emitted by the laser 211.

In some examples, in the case that a first polarization state is a right-handed circular polarization state and a second polarization state is a left-handed circular polarization state, the laser 211 can emit linearly polarized light and unpolarized light. For example, in the case that the light emitted by the laser 211 is the linearly polarized light, a quarter-wave plate can be added at a light-exiting side of the laser 211 to convert the linearly polarized light into circularly polarized light. For example, in the case that the light emitted by the laser 211 is unpolarized light, a polarizer and a quarter-wave plate can be added at a light-exiting side of the laser 211, the polarizer can convert the unpolarized light into the linearly polarized light, and the quarter-wave plate can convert the linearly polarized light into circularly polarized light.

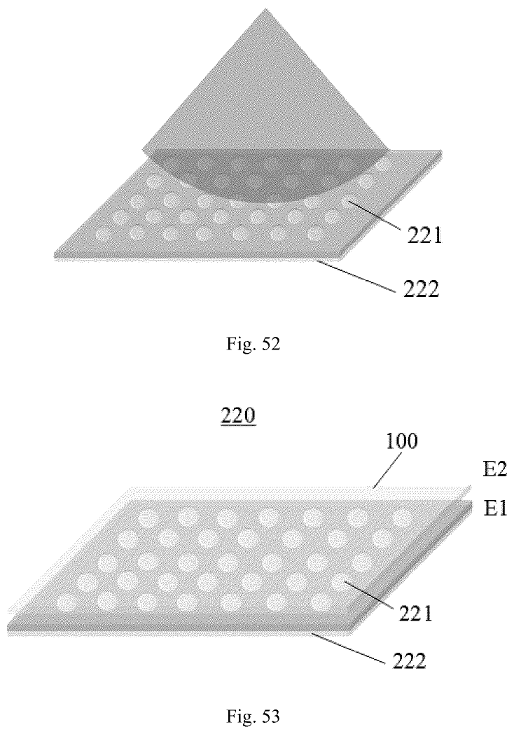

FIG. 52 is a schematic structural diagram of a laser receiving system provided by an embodiment of the present disclosure. As illustrated by FIG. 52, the laser radar further includes a laser receiving system 220, which includes a plurality of detectors 221 configured to receive light beams. The plurality of detectors 221 can receive the light beams reflected from a target, so that relevant information of the target can be obtained. A fan-shaped region in the figure represents that the light beams reflected from the target are received by the laser receiving system 220.

In some examples, as illustrated by FIG. 52, the laser receiving system 220 further includes a second driving chip 222 including a detector driving chip configured to drive the detector 221 to receive the light beams reflected from the target.

In some examples, the laser receiving system 220 further includes a holographic lens, which can converge the light beams reflected from the target, and can converge the reflected light from various directions into a center-incident light beam, and the detector 221 receives the converged light beam.

FIG. 53 is a structural schematic diagram of another laser receiving system provided by an embodiment of the present disclosure. As illustrated by FIG. 53, the laser receiving system 220 includes a plurality of detectors 221 and the light beam deflection device 100, the light beam deflection device 100 is arranged corresponding to the plurality of detectors 221, the plurality of detectors 221 are located at the first side E1 of the light beam deflection device 100 and configured to receive the light beams from the light beam deflection device 100. After the light beams reflected from the target passes through the light beam deflection device 100, the light reflected from various directions can be converged into a center-incident light beam, and the detector 221 receives the converged light beam. Therefore, the light beam deflection device 100 can replace the holographic lens, and the number of the detectors 221 can be reduced, and the size and cost of the laser receiving system 220 can be reduced.

In some examples, as illustrated by FIG. 53, the laser receiving system 220 further includes a second driving chip 222 including a detector driving chip and a light beam deflection device driving chip, the detector driving chip is configured to drive the detector 221 to receive light beams, and the light beam deflection device driving chip is configured to drive the light beam deflection device 100 to deflect the light beams reflected by the target to converge the light beams.

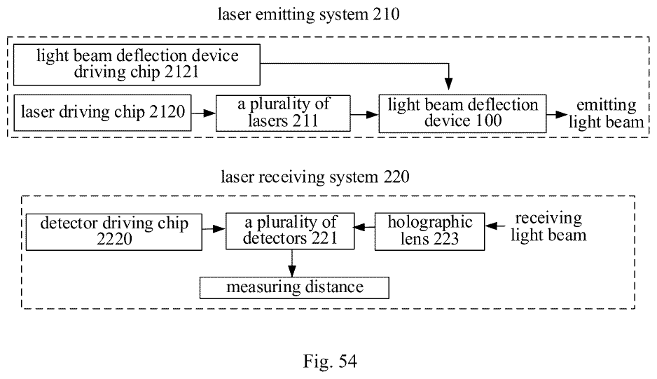

FIG. 54 is a working flow chart of a laser radar provided by an embodiment of the present disclosure. As illustrated by FIG. 54, the laser driving chip 2120 of the laser emitting system 210 drives the laser 211 to emit light beams to the light beam deflection device 100, and the light beam deflection device driving chip 2121 drives the light beam deflection device 100 to deflect the light beams emitted by the laser 211, so as to emit a light beam to the target.

The holographic lens 223 of the laser receiving system 220 converges the light beams reflected by the target into the center-incident light beam, and the detector driving chip 2220 drives the detector 221, the detector 221 receives the converged center-incident light beam. For example, the relevant information of the target can be obtained by the Time of Flight (ToF) distance measurement method.

In some examples, the laser radar may be a FLASH laser radar. The laser 211 may be a vertical-cavity surface-emitting laser (VCSEL). The detector 221 may be a photoelectric detector (PIN-PD). Of course, embodiments of the present disclosure are not limited thereto.

For example, the laser radar can be used in the fields of autonomous driving, intelligent robots, automatic logistics or urban mapping.

The following statements should be noted:
(1) The drawings of the present disclosure involve only the structure(s) in connection with the embodiment(s) of the present disclosure, and other structure(s) can be referred to common design(s).
(2) In case of no conflict, features in one embodiment or in different embodiments can be combined to obtain new embodiments.
   What have been described above are only specific implementations of the present disclosure, the protection scope of the present disclosure is not limited thereto. Any modifications or substitutions easily occur to those skilled in the art within the technical scope of the present disclosure should be within the protection scope of the present disclosure. Therefore, the protection scope of the present disclosure should be based on the protection scope of the claims.

1. A light beam deflection device, comprising a first side and a second side opposite in a first direction, and comprising a light beam deflection structure, the light beam deflection structure comprising:
a liquid crystal variable wave plate, comprising a first liquid crystal layer and a first driver, wherein the first liquid crystal layer comprises a first state and a second state, the first driver is configured to drive the first liquid crystal layer to be in the first state or the second state, in the first state, the liquid crystal variable wave plate is configured to change light of a first polarization state into light of a second polarization state or change light of the second polarization state into light of the first polarization state, and in the second state, the liquid crystal variable wave plate is configured to not to change a polarization state of light; and
a liquid crystal polarization grating, arranged at a side of the liquid crystal variable wave plate away from the first side, and comprising a second liquid crystal layer, wherein the second liquid crystal layer comprises a third state, in the third state, the liquid crystal polarization grating is configured to change light of the first polarization state into light of the second polarization state and deflect the light toward a first deflection direction by a set angle, or change light of the second polarization state into light of the first polarization state and deflect the light toward a second deflection direction by the set angle, and the first deflection direction and the second deflection direction are symmetrical with respect to a propagation direction of the light,
wherein the light beam deflection structure comprises a first light beam deflection structure, the first deflection direction and the second deflection direction of the liquid crystal polarization grating in the first light beam deflection structure are located in a first plane where a first direction and a second direction are located, and the second direction is perpendicular to the first direction,
the light beam deflection device comprises a plurality of first light beam deflection structures which are arranged along the first direction.

2. The light beam deflection device according to claim 1, wherein a periodic arrangement direction of liquid crystal directors of the second liquid crystal layer of the liquid crystal polarization grating in the first light beam deflection structure is the second direction.

3. The light beam deflection device according to claim 1, wherein the first polarization state is a right-handed circularly polarization state, and the second polarization state is a left-handed circularly polarization state.

4. The light beam deflection device according to claim 1, wherein the liquid crystal polarization grating further comprises a second driver, and the second liquid crystal layer further comprises a fourth state, the second driver is configured to drive the second liquid crystal layer so that the second liquid crystal layer is in the third state or the fourth state, and in the fourth state, the liquid crystal polarization grating is configured not to change the polarization state and a deflection angle of the light.

5. The light beam deflection device according to claim 1, wherein numerical values of a plurality of set angles of the plurality of first light beam deflection structures are different.

6. The light beam deflection device according to claim 5, wherein the numerical values of the plurality of set angles form an arithmetic sequence or a geometric sequence.

7.-8. (canceled)

9. The light beam deflection device according to claim 1, wherein the light beam deflection structure further comprises a second light beam deflection structure, the first deflection direction and the second deflection direction of the liquid crystal polarization grating of the second light beam deflection structure are located in a second plane where the first direction and a third direction are located, and the third direction is perpendicular to both the first direction and the second direction,
the light beam deflection device comprises at least one second light beam deflection structure, and the plurality of first light beam deflection structures and the at least one second light beam deflection structure are arranged along the first direction.

10. The light beam deflection device according to claim 9, wherein the at least one second light beam deflection structure is located at a side of the plurality of first light beam deflection structures away from the first side or away from the second side.

11. The light beam deflection device according to claim 9, wherein a periodic arrangement direction of liquid crystal directors of the second liquid crystal layer of the second light beam deflection structure is the third direction.

12. The light beam deflection device according to claim 4, wherein the light beam deflection device comprises a plurality of second light beam deflection structures arranged in the first direction.

13. (canceled)

14. The light beam deflection device according to claim 1, wherein the liquid crystal variable wave plate further comprises:
a first substrate;
a second substrate, arranged opposite to the first substrate, wherein the first liquid crystal layer is located between the first substrate and the second substrate;
a first alignment layer, located between the first liquid crystal layer and the first substrate;
a second alignment layer, located between the first liquid crystal layer and the second substrate;
a first transparent conductive layer, located between the first alignment layer and the first substrate; and
a second transparent conductive layer, located between the second alignment layer and the second substrate,
wherein, the first driver comprises the first transparent conductive layer and the second transparent conductive layer, in a case that a voltage signal between the first transparent conductive layer and the second transparent conductive layer is a first voltage, the first liquid crystal layer is in the first state, and in a case that the voltage signal between the first transparent conductive layer and the second transparent conductive layer is a second voltage, the first liquid crystal layer is in the second state.

15. (canceled)

16. The light beam deflection device according to claim 14, wherein the liquid crystal variable wave plate further comprises:
a first antireflection film, located at a side of the first substrate away from the first transparent conductive layer; and
a second antireflection film, located at a side of the second substrate away from the second transparent conductive layer.

17. The light beam deflection device according to claim 1, wherein the liquid crystal variable wave plate further comprises:
a first substrate;
a second substrate, arranged opposite to the first substrate, wherein the first liquid crystal layer is located between the first substrate and the second substrate;
a first alignment layer, located between the first liquid crystal layer and the first substrate;
a second alignment layer, located between the first liquid crystal layer and the second substrate;
a first transparent conductive layer, located between the first alignment layer and the first substrate;
a second transparent conductive layer, located between the second alignment layer and the second substrate;
a first quarter-wave plate, located at a side of the first substrate close to the first side; and
a second quarter-wave plate, located at a side of the second substrate away from the first side,
wherein, the first driver comprises the first transparent conductive layer and the second transparent conductive layer, in a case that a voltage signal between the first transparent conductive layer and the second transparent conductive layer is a first voltage, the first liquid crystal layer is in the first state, and in a case that the voltage signal between the first transparent conductive layer and the second transparent conductive layer is a second voltage, the first liquid crystal layer is in the second state.

18. (canceled)

19. The light beam deflection device according to claim 14, wherein the liquid crystal polarization grating comprises:
a third substrate;
a fourth substrate, arranged opposite to the third substrate, wherein the second liquid crystal layer is located between the third substrate and the fourth substrate;
a third alignment layer, located between the second liquid crystal layer and the third substrate; and
a fourth alignment layer, located between the second liquid crystal layer and the fourth substrate.

20. The light beam deflection device according to claim 19, wherein the second substrate is located at a side of the first substrate away from the first side, and the fourth substrate is located at a side of the third substrate away from the first side, the second substrate and the third substrate are a same substrate.

21. The light beam deflection device according to claim 4, wherein the liquid crystal polarization grating comprises:
a third substrate;
a fourth substrate, arranged opposite to the third substrate, wherein the second liquid crystal layer is located between the third substrate and the fourth substrate;
a third alignment layer, located between the second liquid crystal layer and the third substrate;
a fourth alignment layer, located between the second liquid crystal layer and the fourth substrate;
a third transparent conductive layer, located between the third alignment layer and the third substrate; and
a fourth transparent conductive layer, located between the fourth alignment layer and the fourth substrate,
wherein the second driver comprises the third transparent conductive layer and the fourth transparent conductive layer, in a case that a voltage signal between the third transparent conductive layer and the fourth transparent conductive layer is a third voltage, the second liquid crystal layer is in the third state, and in a case that the voltage signal between the third transparent conductive layer and the fourth transparent conductive layer is a fourth voltage, the second liquid crystal layer is in the fourth state.

22. The light beam deflection device according to claim 1, further comprising:
a controller, connected and in communication with a plurality of first drivers of the plurality of first light beam deflection structures and is configured to provide voltage signals to the plurality of first drivers to make the first liquid crystal layer in the first state or the second state.

23. A laser radar, comprising a laser emitting system, wherein the laser emitting system comprises a plurality of lasers and the light beam deflection device according to claim 1, and the plurality of lasers are arranged corresponding to the light beam deflection device,
the plurality of lasers are located at the first side of the light beam deflection device and are configured to emit light beams to the light beam deflection device.

24. The laser radar according to claim 23, further comprising a laser receiving system, which comprises a plurality of detectors, wherein the plurality of detectors are configured to receive light beams.

25. The laser radar according to claim 24, wherein the laser receiving system further comprises the light beam deflection device, and the light beam deflection device is arranged corresponding to the plurality of detectors, the plurality of detectors are located at the first side of the light beam deflection device, and the plurality of detectors are configured to receive a light beam from the light beam deflection device.
